(19) United States
(12) Patent Application Publication
(10) Pub. No.: US 2013/0232377 A1
(43) Pub. Date: Sep. 5, 2013

(54) METHOD FOR REUSING RESOURCE AND STORAGE SUB-SYSTEM USING THE SAME

(71) Applicants: Shinobu Kakihara, Odawara (JP); Makoto Masuda, Hiratsuka (JP); Mitsuhide Sato, Oiso (JP)

(72) Inventors: Shinobu Kakihara, Odawara (JP); Makoto Masuda, Hiratsuka (JP); Mitsuhide Sato, Oiso (JP)

(73) Assignee: HITACHI, LTD., Tokyo (JP)

(21) Appl. No.: 13/395,025

(22) PCT Filed: Mar. 1, 2012
(86) PCT No.: PCT/JP2012/001415

§ 371 Date: Mar. 8, 2012

(51) Int. Cl. G06F 11/20

(52) U.S. Cl. 714/6.13; 714/E11.085

(57) ABSTRACT

In a storage sub-system adopting a redundant configuration for preventing data loss and continuing processing during failure, when failure occurs, a controller unit in which failure has occurred is blocked so as not to affect the normal controller unit, so that the performance of the storage sub-system is deteriorated and the redundancy thereof is lost until maintenance and component replacement is performed. According to the present invention, self diagnosis of the blocked area is executed and a failure area is isolated. Then, the blocked area is reconnected to the storage sub-system, so as to prevent deterioration of performance and overload of the device until maintenance and replacement is performed, and to reduce the time of failure analysis during maintenance by specifying the detailed failure area via self diagnosis.

### TECHNICAL FIELD

The present invention relates to a method for reusing resources when failure occurs, and a storage sub-system using the method for reusing resources.

### BACKGROUND ART

In a storage sub-system having a controller adopting a redundant configuration (cluster configuration), when failure occurs to one of the controller units, the whole controller unit must be blocked even though there are resources that do not have failure existing within the controller unit in which failure has occurred, and the other controller unit takes over the operation. In contrast, there is an art related to the efficient use of resources and improved performance of the storage sub-system in the event of a failure that has occurred to one of the controller units by specifying the resource having failure in the controller unit in which failure has occurred, blocking only the specified resource and continuing use of the other resources not having failure. One example of such art is disclosed in patent literature 1.

The art disclosed in patent literature 1 relates to a storage sub-system capable of minimizing the influence of deterioration of performance when failure occurs to a portion of a cache memory by utilizing a memory area other than the failure memory area of the controller unit experiencing failure without taking over all the I/O accesses thereof by an external controller unit. In detail, the art disclosed in patent document 1 relates to a storage sub-system having dual cache memories, wherein if failure occurs to a portion of the cache memory, only a memory area (Area1) in which failure has occurred is blocked and reallocation thereof to another memory area (Area2) of the same cache memory is conducted to continue the I/O access processing.

### CITATION LIST

### Patent Literature

PTL 1: Japanese Patent Application Laid-Open Publication No. 2008-269142 (U.S. Pat. No. 7,774,640)

### SUMMARY OF INVENTION

### Technical Problem

According to the prior art disclosed in patent literature 1, the cache memory as resource can be utilized efficiently, but on the other hand, since host access is performed continuously, the use of the failure resource is continued until the failure resource is specified. Therefore, there is a risk that the failure of the failure resource is propagated (possibly causing another failure), and the failure resource may become a bottleneck of processing by which the performance of the storage sub-system may be deteriorated.

When failure occurs, the whole controller experiencing failure including the failure resource is blocked so as not to affect the normal controller unit within the storage sub-system, so that until maintenance and replacement of the component is performed, the performance and the reliability of the storage sub-system is deteriorated.

### Solution to Problem

In order to solve the problems mentioned above, according to the storage sub-system of the present invention, when one controller unit detects failure of the other controller unit, the whole controller unit in which failure has occurred is blocked temporarily. After blockage, the resource in which failure has occurred is specified under the control of an MP (Micro-Processor) within the failure controller unit. After the MP has specified the resource in which failure has occurred, the present invention reconnects only the resource having no failure. Further, the present invention orders self diagnosis to be performed to the area of the resource blocked and isolated from the system after failure has occurred. The specific area of failure is specified by the self diagnosis. The specified failure area is isolated, and if there is any area that can be reconnected to the system, the area is returned to the operation status again.

More specifically, the present invention provides a storage sub-system coupled to a host computer, comprising a storage device unit for storing data sent from the host computer, and a management unit for managing a memory area of the storage device unit, wherein when failure occurs to the storage device unit of the management unit itself, the management unit specifies an area in which failure has occurred and isolates the area from the storage sub-system, analyzes the area in which failure has occurred to specify the specific failure area, and reconnects the area excluding the specified specific failure area to the storage sub-system. In addition, when failure occurs, a normal management unit blocks the management unit or the storage device unit in which failure has occurred, and acquires a failure information thereof.

Even further according to the invention, when failure occurs, the normal management unit orders execution of a self diagnosis operation regarding the management unit or the storage device unit in which failure has occurred, so as to specify the specific failure area. In addition, if the failure area is detected via the self diagnosis, a detailed failure information including a specific failure area information and failure contents is acquired and the detailed failure information is stored in a non-volatile memory of the management unit, wherein a specific failure area is specified and blocked based on the detailed failure information and a failure management information determining a blocked area and a reconnection availability, and a failure area isolation information is created.

According further to the present invention, the specific failure area blocked based on the failure area isolation information is isolated from the normal area so as to perform reconnection to the storage sub-system and reoperation thereof. Even further, the re-connection to the storage sub-system and reoperation thereof is performed by updating a failure status information via the failure area isolation information, updating a load status management information and an associated storage device information, and planarizing the load of each area within the storage sub-system.

### Advantageous Effects of Invention

According to the method for reusing resources according to the present invention, the deterioration of performance of the storage sub-system or the risk of system overload can be minimized during failure before maintenance and replacement is performed.

### BRIEF DESCRIPTION OF DRAWINGS

FIG. 1 is a block diagram illustrating a storage system configuration and a configuration of the interior of the storage sub-system.

FIG. 2 is a view showing a configuration of a FE (Front End) unit of the storage sub-system.

FIG. 3 is a view showing a configuration of a BE (Back End) unit of the storage sub-system.

FIG. 4 is a view showing a configuration of an ENC (enclosure) unit of the storage sub-system.

FIG. 5A is a view showing a 2 CPU×2 core configuration of a CPU (Central Processing Unit) of the storage sub-system.

FIG. 5B is a view showing a 1 CPU×2 core configuration of the storage sub-system.

FIG. 6 is a view showing a configuration example of an associated LU management table.

FIG. 7 is a view showing a configuration example of a cache allocation management table.

FIG. 8 is a view showing a configuration example of a resource load status management table.

FIG. 9 is a block diagram showing the I/O access from the host to the storage sub-system.

FIG. 10 is a flowchart showing the I/O access processing from the host to the storage sub-system.

FIG. 11 is a view showing a configuration example of a failure management table.

FIG. 12A is a view showing a configuration example of a failure status table (controller unit 0).

FIG. 12B is a view showing a configuration example of a failure status table (controller unit 1).

FIG. 13A is a view showing a configuration example of a configuration confirmation table when failure occurs in an FE.

FIG. 13B is a view showing a configuration confirmation table when failure occurs in a cache module.

FIG. 14 is a view showing a configuration example of a replacement area table.

FIG. 15 is a flowchart showing a process for specifying the area in which failure has occurred.

FIG. 16 is a flowchart showing a self diagnosis processing.

FIG. 17A is a flowchart showing a maintenance and response according to a failure notice level.

FIG. 17B is a view showing a configuration example of a management terminal screen.

FIG. 18 is a flowchart showing the processing of an I/O access in a normal controller unit during blockage of an abnormal controller unit.

FIG. 19 shows a process for reconnecting a normal resource to the system when failure occurs at a data transfer control unit.

FIG. 20 is a flowchart showing a process for reconnecting an isolated normal resource to the system.

FIG. 21 is a view showing a process for reconnecting a normal resource to the system when failure occurs at a CPU.

FIG. 22 is a view showing a process for reconnecting a normal resource to the system when failure occurs at a cache memory.

FIG. 23 is a view showing a process for reconnecting a normal resource to the system when failure occurs at a BE.

FIG. 24 is a view showing a process for reconnecting a normal resource to the system when failure occurs at an expander.

### DESCRIPTION OF EMBODIMENTS

Now, the preferred embodiments of the present invention will be described with reference to the drawings. In the description, various information are referred to as “management table”, but the various information can be expressed via data structures other than tables. Further, the “management table” can also be referred to as “management information” to show that the information does not depend on the data structure.

The processes are sometimes described using the term “program” as the subject. The program is executed by a processor such as a CPU (Central Processing Unit) for performing determined processes. A processor can also be the subject of the processes since the processes are performed using appropriate storage resources (such as memories) and communication interface devices (such as communication ports). The processor can also use dedicated hardware in addition to the CPU. The computer program can be installed to each computer from a program source. The program source can be provided via a program distribution server or a storage media, for example.

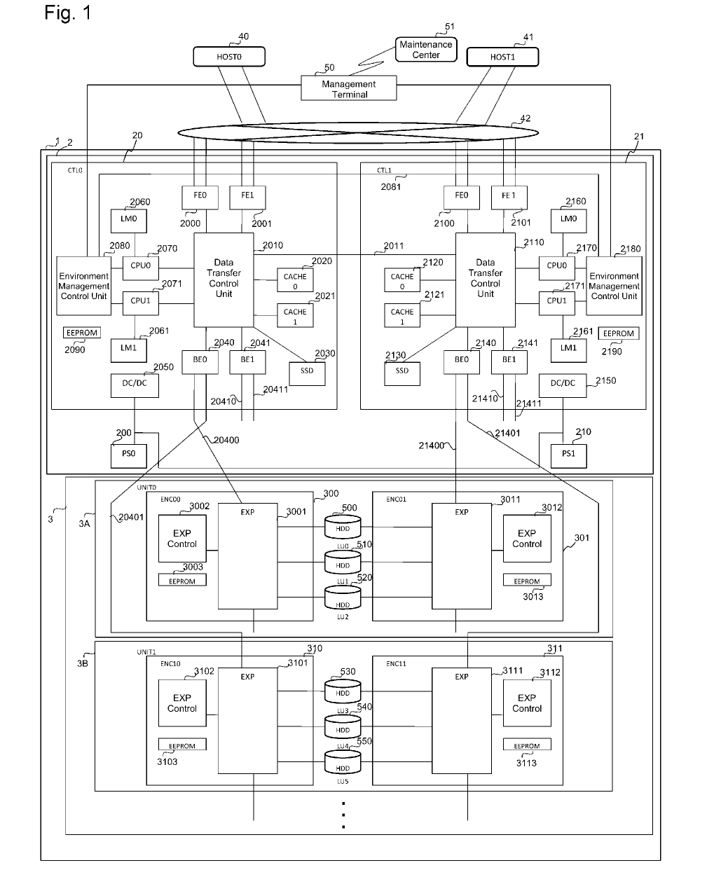

Each element such as an LU (Logical Unit) can be identified via numbers, but other types of identification information such as names can be used as long as they are identifiable information. The equivalent elements are provided with the same reference numbers in the drawings and the description of the present invention, but the present invention is not restricted to the present embodiments, and other modified examples matching the idea of the present invention are included in the technical range of the present invention. The number of each component can be one or more than one unless defined otherwise.

<<System Configuration>>

<Storage System Configuration (FIG. 1)>

FIG. 1 is a block diagram illustrating a storage system configuration and the configuration of the interior of the storage system. First, in FIG. 1, the overall configuration of the storage system adopting the present invention will be described. The storage system is composed of a storage sub-system 1, HOST0 40 and HOST1 41 and a management terminal 50. The storage sub-system 1 is coupled to HOST0 40 and HOST1 41 via a network 42.

Moreover, the storage sub-system 1 is directly coupled to the management terminal 50 managing the configuration information of the storage sub-system 1 or the monitoring of the operation status and occurrence of failure in the storage sub-system 1, but the devices can also be coupled via a network 42. The management terminal 50 is coupled to a maintenance center 51 via a LAN or a telephone circuit. The maintenance center 51 is capable of managing the configuration information and monitoring, the operation status and the occurrence of failure of the storage sub-system 1.

The above-described network 42 is formed of a wired line such as a metal cable or an optical fiber cable, for example. However, the respective HOST0 40 and HOST1 41 and the storage sub-system 1 or the storage sub-system 1 and the management terminal 50 can also be connected via wireless communication. Moreover, the network 42 can be a SAN (Storage Area Network) or a LAN (Local Area Network), for example.

<Internal Configuration of Storage Device (FIG. 1)>

Next, the internal configuration of the storage sub-system 1 will be described similarly with reference to FIG. 1. The storage sub-system 1 is composed of a controller housing 2 and a drive housing 3. For enhanced reliability of the system, the storage sub-system 1 adopts a duplex configuration composed of a controller unit 0 (CTL0) 20 and a controller unit 1 (CTL1) 21, a DC/DC converter unit (hereinafter referred to as DC/DC unit DC/DC0) 200 and a DC/DC unit (DC/DC1) 210 disposed within the controller housing 2. The drive housing 3 is composed of an enclosure unit 0 (ENC0) 300 and an enclosure unit 1 (ENC1) 310 which are drive controller units, and a plurality of HDDs (Hard Disk Drives).

Since the devices constituting the controller unit 0 (CTL0) 20 and the controller unit 1 (CTL1) 21 of the controller housing 2 are the same, only the controller unit 0 (CTL0) 20 will be described. FE (Front End)_I/F controller units (hereinafter referred to as FE) 2000 and 2001 which are host communication control units are composed of a controller for realizing communication between the HOST0 40 or HOST1 41 and the storage sub-system 1 (control housing 2) via the network 42, and a program operating in the controller.

Similarly, BE (Back End)_I/F controller units (hereinafter referred to as BE) 2040 and 2041 are composed of a controller for performing communication between the control housing 2 and the drive housing 3, and a program operating in the controller.

CPU0 2070 and CPU1 2071 are processors for controlling the whole controller unit 0 of the storage sub-system 1. Local memories (hereinafter referred to as LM) 2060 and 2061 are memories for enabling the CPU 0 2070 or CPU1 2071 to access control information, management information and data at high speed.

Cache memories (hereinafter referred to as CACHE) 2020 and 2021 are each composed of a few to a few dozen memory modules each using a plurality of DDR (Double Data Rate) type synchronous volatile memories (SDRAM: Synchronous Dynamic Random Access Memory).

The CACHE0 2020 and CACHE1 2021 are memories for storing various programs and management tables or other control information used in CTL0 20 and for temporarily storing user data sent from the HOST0 40 or user data stored in the HDD. In other words, in order to prevent accessing the HDD requiring a long access time each time, a portion of the user data is stored in a cache that can be accessed via a shorter time than the HDD. Furthermore, the cache also functions to enhance the speed of accesses from the host to the storage sub-systems.

An SSD (Solid State Drive) 2030 is a drive composed for example of a flash memory which is a nonvolatile semiconductor memory. The SSD is generally composed of a rewritable nonvolatile semiconductor memory such as a flash memory, but it can also be composed of other storage devices capable of retaining data without receiving power supply, such as a high speed HHD or an optical media device.

A data transfer control unit 2010 is a controller for controlling commands and data transfer among respective devices such as FE, BE, CACHE, CPU, LM and SSD. An EEPROM (Electrically Erasable Programmable Read-Only Memory) 2090 or 2190 stores therein a self-diagnostic program, a failure management reference table and a failure information described in detail later, which can be accessed from CPUs and various controllers for responding to failure.

An environment management control unit 2080 is a control unit for monitoring and controlling the device operation environment of the whole storage sub-system 1 including monitoring temperature of respective areas and respective devices within the storage sub-system 1, controlling temperature by controlling the rotation of fans, and monitoring an external power supply status, or a power supply status, and a battery status. An environment management control unit 2080 is coupled to an environment management control unit 2180 of an external system controller unit 1 21 via a HOTLINE signal 2081 which is a dedicated line, sending and receiving information on the operation status of the respective controller units and the failure information thereof using a GPIO (General Purpose I/O) resister (not shown) which is an internal resister. The details of contents and operations thereof will be illustrated later.

A power supply PS0 200 is composed of a power supply control unit, an AC/DC converter and a battery, although not shown. Power is fed in the form of single phase/three phase 100 volt (V)/200 V voltage AC power to the power supply PS0 200 from an external power supply. The PS0 200 converts the supplied AC voltage via the AC/DC converter to a DC voltage having a predetermined voltage.

The predetermined DC voltage converted via the AC/DC converter is further converted via a DC/DC converter (DC/DC) 2050 into various voltages corresponding to a 50 V voltage for charging power to the battery, a 5V/12V voltage for operating the HDD, and a 2V/3V voltage for operating the semiconductor device, before being supplied to the respective devices. The battery within the PS0 200 (not shown) is formed of a plurality of lithium-ion type or nickel-hydride type chargeable-dis-chargeable secondary battery cells so as to enable a predetermined amount of power having a predetermined DC voltage to be supplied to the controller unit.

A large number of HDDs from HDD 500 to HDD 520 are coupled via an expander (EXP) 3001 for enabling coupling of a number of HDDs greater than the number of HDD interface ports determined by standards within an ENC00 300 of the drive housing 3. Fiber channel (hereinafter referred to as FC) type devices having extremely high reliability but expensive, inexpensive SAS (Serial Attached SCSI) type devices and SATA (Serial AT Attachment) type devices which is even more inexpensive than SAS can be used as the HDDs. A plurality of HDDs are used to compose an LU (Logical Unit) and store user data from the HOST0 40 or HOST1 41.

An EXP control unit 3002 uses control programs such as a disk I/O program and control information stored in an EEPROM 3003 which is a nonvolatile semiconductor memory to control the EXP 3001 and to control accesses from the controller housing 2 to the HDD. ENC01, ENC10 and ENC11 are similar to ENC00, so descriptions thereof are omitted.

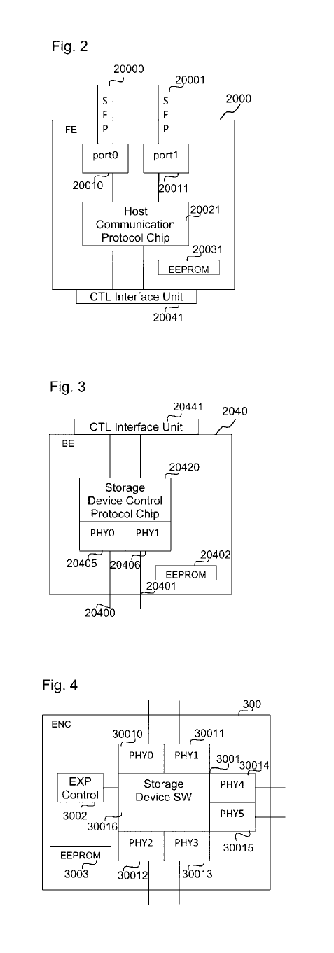

Further, the storage sub-system 1 forms a single controller system (internal system or first system) by the CTL0 20, the PS0 200 and the ENC00 300 / ENC10 310, and similarly forms a single controller system (external system or second system) by CTL1 21, PS1 210 and ENC01 301/ENC11 311. The present duplicated configuration enables the storage sub-system 1 to be a highly reliable and highly useful system. The present embodiment illustrates a duplicated system, but the system can be multiplexed into three or more systems.

<Internal Configuration of Device (FIGS. 2-5B)>

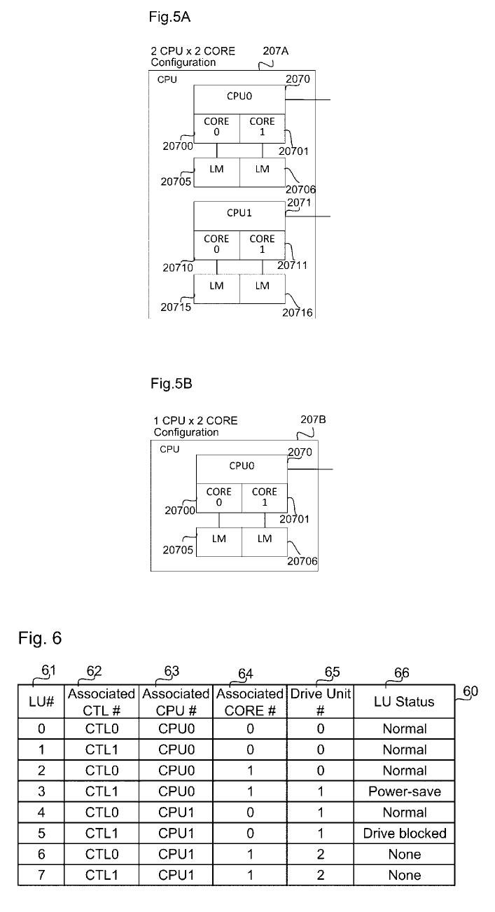

Next, the detailed internal configuration of the main devices within the storage sub-system will be described with reference to FIGS. 2 through 5B. FIG. 2 is a view showing the configuration of an FE unit of the storage sub-system. FIG. 3 is a view showing the configuration of a BE unit of the storage sub-system. FIG. 4 is a view showing the configuration of an ENC unit of the storage sub-system. FIG. 5A is a view showing the CPU of the storage sub-system adopting a 2 CPU×2 core configuration. FIG. 5B is a view showing the CPU of the storage sub-system adopting a 1 CPU×2 core configuration.

First, the internal configuration and operation of the FE unit will be described with reference to FIG. 2. The FE unit 2000 is composed of connector units 20000 and 20001, connection port units 20010 and 20011, a host communication protocol chip unit 20021, an EEPROM 20031 and a CTL interface unit 20041.

Connector units 20000 and 20001 are pluggable connectors meeting the standards of SFP (Small Form factor Pluggable) which is one of the standards of an optical transceiver for coupling an optical fiber to a communication equipment. Connection port units 20010 and 20011 are physically coupled to the host communication protocol chip unit 20021 for sending and receiving data and commands related to I/O access requests from the HOST0 40 and the like.

The host communication protocol chip unit 20021 is connected to the connection port units 20010 and 20011 and is also connected to a data transfer control unit 2010 via a CTL interface unit 20041, so as to establish an interface between the HOST0 40/HOST1 41 and the CTL unit0 20 of the storage sub-system 1, for example. The EEPROM 20031 is a nonvolatile semiconductor memory for storing control information such as a management table or a control program used by the host communication protocol chip unit 20021. The internal configuration and operation of the FE unit 2000 has been described here, but the other FE units 2001 and the like have the same configuration and operate in the same manner

Next, the internal configuration and the operation of a BE unit will be illustrated with reference to FIG. 3. The BE unit 2040 is composed of a CTL interface unit 20441, a storage device control protocol chip unit 20420, physical connection port units PHY0 20405 and PHY1 20406, and an EEPROM 20402.

The storage device control protocol chip unit 20420 is coupled to a data transfer control unit 2010 via the CTL interface unit 20441. Further, the storage device control protocol chip unit 20420 is coupled to an EXP of an ENC of a drive housing 3 via physical connection port units PHY0 20405 and PHY1 20406, so as to enable transmission and reception of data and commands of I/O accesses between the CTL0 20 and the ENC00 300 or ENC10 310. The EEPROM 20402 is a nonvolatile semi-conductor memory for storing control information such as management tables and control programs used by the storage device control protocol chip unit 20420. Here, the internal configuration and the operation of the BE unit 2040 has been described, but the other BE unit 2041 or the like have the same configuration and operate in the same manner.

Next, the internal configuration and operation of an ENC unit will be described with reference to FIG. 4. The ENC unit 300 is composed of a storage device switch unit 30016 having physical connection port units PHY0 30010, PHY1 30011, PHY2 30012, PHY3 30013, PHY4 30014 and PHY5 30015, an EXP control unit 3002 and an EEPROM 3003.

The physical connection port units PHY0 30010 and PHY1 30011 are coupled to BE unit 2040 and BE unit 2041 via cables and other connection lines 20400 and 20410. The physical connection port units PHY2 30012 and PHY3 30013 are respectively coupled to HDDs 500 through 520. The physical connection port units PHY4 30014 and PHY5 30015 are connected to other ENCs such as EXP 3010 of ENC10 of disk unit (hereinafter referred to as UNIT) 1 3B.

The storage device switch unit 30016 is for realizing connection with the BE unit, respective HDDs and other ENCs, and connects devices via the control of the EXP control unit 3002. For example, when data is written from the host to the LU0, the switch connects the BE unit and the HDD 500. The EEPROM 3003 is a nonvolatile semiconductor memory for storing control information such as management tables and control programs used by the EXP control unit 3002. Here, the internal configuration of the ENC00 300 and the operation thereof has been described, but the other ENC01 301 and the like have the same configuration and operate in the same manner.

Next, the internal configuration of a CPU unit will be described with reference to FIGS. 5A and 5B. A CPU unit 207A is composed of a CPU0 2070 including a CORE0 20700 and a CORE1 20701 which are processing units (CORE), a CPU1 2071 including a CORE0 20710 and a CORE1 20711, and LMs 20705, 20706, 20715 and 20716 coupled to the respective processing units and realizing high speed access. This configuration is called a 2 CPU×2 CORE (Dual Core) configuration. In contrast, FIG. 5B is called a 1 CPU×2 CORE configuration. A CPU unit having an even higher performance adopts a 4 CPU×4 CORE (Quad Core) configuration.

<Device Management Tables (FIGS. 6-8)>

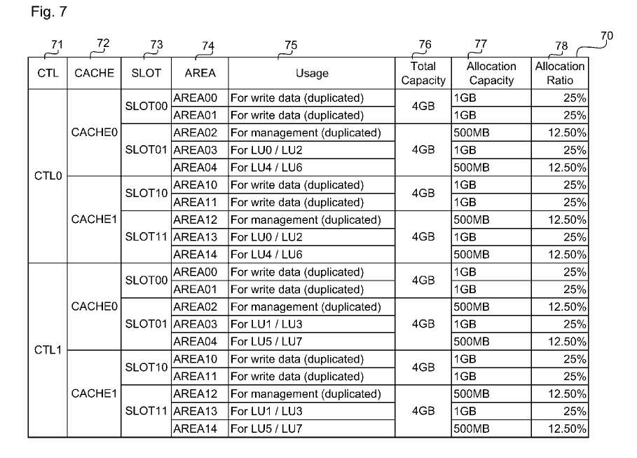

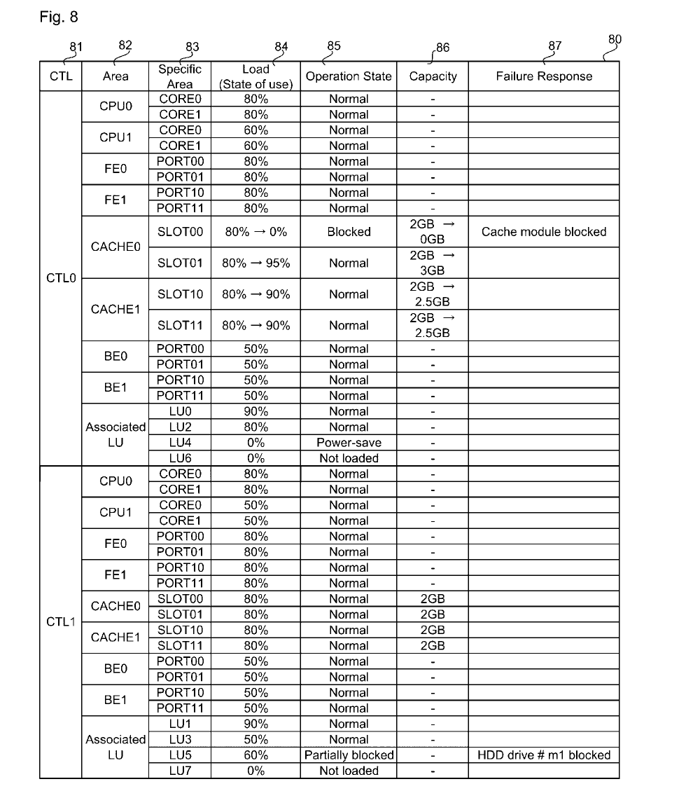

Next, an example of tables used in the operated state of the storage sub-system 1 will be described with reference to FIGS. 6 through 8. FIG. 6 is a view showing a configuration example of an associated LU management table. FIG. 7 is a view showing a configuration example of a cache allocation management table. FIG. 8 is a view showing a configuration example of a resource load status management table.

At first, a configuration of an associated LU management table 60 managing the LU ownership will be described with reference to FIG. 6. The associated LU management table 60 is for managing the corresponding relationship between each LU, the CPU or the CPU core in charge of the processing regarding the LU, and the LU status. The associated LU management table 60 is composed of an LU number 61, an associated CTL number 62, an associated CPU number 63, an associated core number 64, a unit number 65 of the drive housing, and an LU status 66 for discriminating the statuses such as normal/power saving/blocked/unused.

For example, when access occurs to LU0 (HDD group 500) in which the LU number 61 of the drive housing UNIT0 3A from the HOT0 40 is “0”, it can be recognized that the CPU processing the access and the core thereof is CORE0 of CPU0 of CTL0 based on the associated LU management table 60. Further, as for LU1 (HDD group 510) in which the LU number 61 allocated to UNIT0 of the same drive housing is “1”, the CTL1 21 will be in charge of the accesses. Moreover, the LU and the CPU or the core in charge of the processes will be changed arbitrarily so as to realize a maximum performance of the storage sub-system 1 according to the status of load of each CPU and each core or the occurrence of failure. Upon changing the associated LU, the LU ownership management table 60 will be updated.

Thereafter, the configuration of a cache management table 70 will be described with reference to FIG. 7. The cache management table 70 is for managing the usage of the cache, the allocation capacity and the like, composed of a CTL type 71, a cache group number 72, a slot number 73, a cache area 74, a usage 75, a cache memory total capacity 76, an allocation capacity (usable capacity) 77 and an allocation ratio 78.

For example, if the CTL type 71 is “CTL0”, the cache group number 72 is “CACHE0” and the slot number 73 is “SLOT00”, the total capacity of the cache memory is 4 GB (Giga Bytes) as shown in the cache memory total capacity 76.

Further, regarding slot number “SLOT00”, the cache has allocated thereto cache areas “AREA00” and “AREA01” having an allocation capacity of 1 GB and an allocation ratio (allocation capacity/total capacity) of 25%, and based on the usage 75, it can be recognized that the cache is used for “host write data (duplication)”.

Similarly, slot number “SLOT01” has allocated thereto cache areas “AREA02”, “AREA03” and “AREA04” having an allocation capacity of 500 MB, 1 GB and 500 MB and allocation ratio of 12.50%, 25% and 12.50%. The usage of cache areas “AREA02”, “AREA03” and “AREA04” are “system management (duplication)”, “LU0/LU2 access” and “LU4/LU6 access”, respectively. CACHE1 and controller unit CTL1 are managed in a similar manner The storage sub-system 1 uses this cache management table 70 to dynamically change the allocation capacity of the cache based on the load statuses and the usage of the respective devices so as to realize optimum performance.

Next, the configuration of a load status management table 80 will be described with reference to FIG. 8. The present table is for managing the load statuses of the respective areas (devices) so as to planarize the load balance and realize optimum performance

A load status management table 80 is composed of a CTL type 81, an area 82, a specific area 83, a load (used state) 84, an operation status 85, an allocation capacity (cache capacity) 86, and a response to failure 87. The CTL type 81 is used to distinguish controller units CTL0 and CTL1, and the area 82 shows the device level (component level) classification, wherein the area 82 includes CPU, FE, cache, BE and associated LU (HDD group).

The specific area 83 refers to the internal area of each area 82. For example, the CPU is composed of two cores, so in the table where the area 82 is “CPU0”, the specific area 83 includes “CORE0” and “CORE1”, and the load 84 of each specific area 83 is managed in the table.

The load 84 shows the usage rate of each area, which is illustrated within the range of 0 to 100%. For example, the load 84 of CORE0 of CPU0 is “80%, the operation status 85 is “normal” and the failure response 87 is vacant. If the usage rate is 100%, it may be highly possible that the area is in an overloaded state and load distribution is necessary.

The operation status 85 and the failure response 87 are mainly used in pairs, such as in the table where the CTL type 81 is “CTL0” and area 82 is “CACHED”, the operation status 85 of specific area 83 “SLOT00” is in “blocked” state since failure has occurred, so that the response to failure 87 shows “cache module blocked”, the load 84 is “0% and the allocation capacity is also “0 GB”.

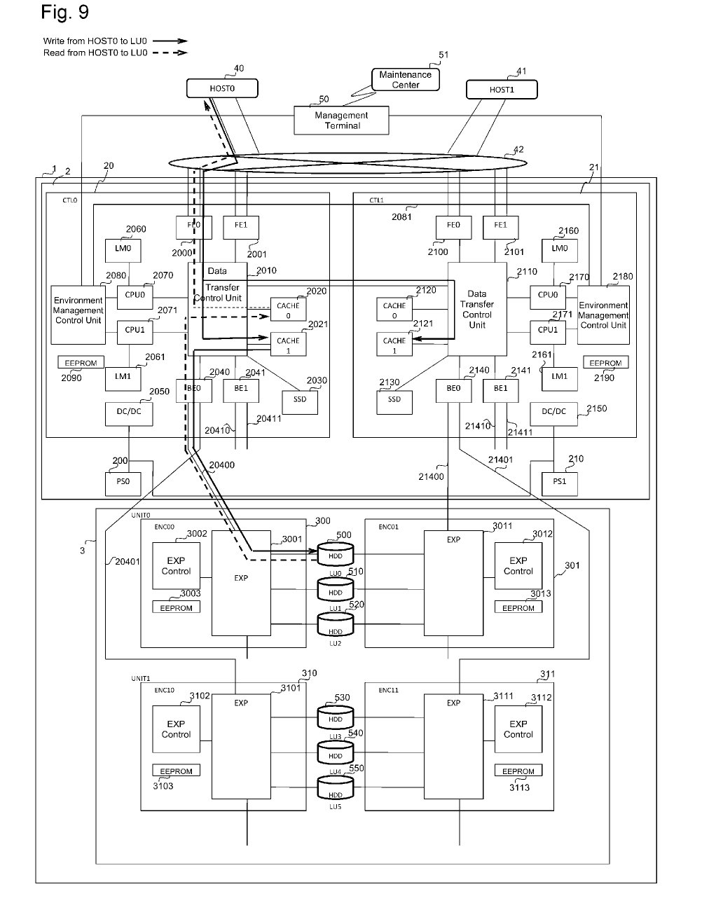

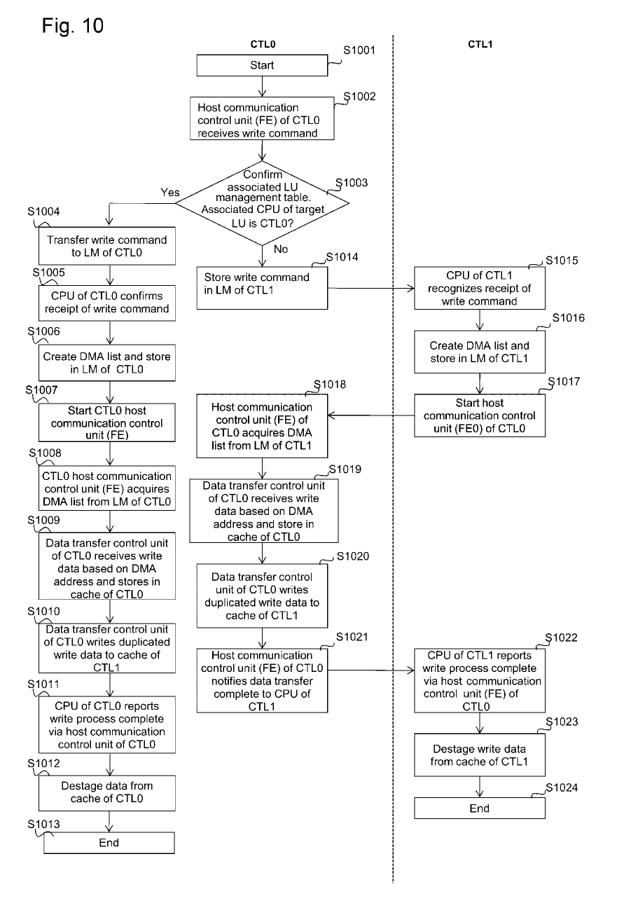

In order to prevent deterioration of performance of data writing and reading processes in the storage sub-system caused by the failure of CACHE0, load is distributed by increasing the allocation capacity of SLOT00 of CACHE0 and CACHE1 from 2 GB to 3 GB or to 2.5 GB. Further, the operation status 85 includes “normal”, “blocked”, “power save” and so on, wherein when the state is blocked or power save, the load becomes 0%. By using the aforementioned associated LU management table 60, the cache management table 70 and the load status management table 80, the storage sub-system 1 performs load distribution so that the whole device exerts optimum performance

<I/O Access Operation during Normal State (FIGS. 9-10)>

<I/O Write Access Request>

Next, the I/O access operation during the normal state will be described with reference to FIGS. 9 and 10. FIG. 9 is a block diagram showing the processing of I/O access from the HOST0 40 or the HOST1 41 to the storage sub-system 1. FIG. 10 is a flowchart showing the processing of I/O access from HOST0 40 or HOST1 41 to the storage sub-system 1.

At first, the processing and the operation of an I/O write access request (hereinafter referred to as write request) will be described. At first, HOST0 40 sends a write request via a network 42 to the storage sub-system 1. In storage sub-system 1, the FE0 2000 which is a host communication control unit of CTL0 20 receives the write command and the write data of the write request (S1002).

Next, the CTL0 20 having received the write request confirms via the associated LU management table 60 whether the CPU in charge of the processing of the write target LU is the internal CPU (within CTL0) or not (S1003). If the write request should be processed in CTL0 20, the CTL0 20 executes the processes of steps S1004 and thereafter. For example, regarding LU0 500 in which the LU number 61 is “0” in the associated LU management table 60, the CPU0 of CTL0 20 is in charge of the processes. Therefore, when a write request to LU0 is received, the CTL0 20 executes the processes.

If the write request is a request not to be processed by CTL0 20 (that should be processed by CTL1 21), the processes of steps S1014 and thereafter are executed via both controller units CTL0 20 and CTL1 21. For example, regarding LU5 550 in which the LU number 61 is “5” in the associated LU management table 60, the CPU1 of CTL1 21 will be in charge of the processes. Therefore, the CTL0 20 transfers the received write request to LU5 550 to the CTL1 21, and the write request is processed in CTL1 21.

As described, the operation in which a plurality of logical resources (controller units) are activated, and if failure occurs to one logical resource, the process is subjected to fail-over processing to another logical resource to thereby continue the processing, is called an active/active operation. In order to simplify the description, since the write processing of steps 1004 and thereafter are associated with LU0, the CPU0 of CTL0 20 performs the processing, and since the processes of steps 1014 and thereafter are associated with LU5, the CPU1 2171 of CTL1 21 performs the processing.

If the write request is to be processed by CTL0 20 (S1003: Yes), the data transfer control unit 2010 of CTL0 20 stores the write command in LM0 2060 of CTL0 20 (S1004). Next, the CPU0 2070 of CTL0 20 searches the LM0 2060 and confirms the received write command (S1005).

Next, the CPU0 2070 of CTL0 20 creates a DMA list (a control information (such as the transfer destination address and the transfer data capacity) for a DMAC (Direct Memory Access Controller) to transfer data to the cache), and stores the same in LM0 2060 (S1006). Thereafter, the CPU0 2070 activates FE0 2000 which is a host communication control unit of CTL0 20 (S1007). Then, the FE0 2000 which is a host communication control unit of CTL0 20 acquires the DMA list from LM0 2060 of CTL0 20 (S1008).

Thereafter, based on the DMA address in the acquired DMA list, the data transfer control unit 2010 of CTL0 20 receives the write data from the FE0 2000 and stores the same in CACHE1 2021 of CTL0 (S1009). As shown in cache management table 70, the access area for write data (duplication) is formed in both caches (CACHE0 and CACHE1), so that the write data to the cache can be stored in any one of the caches. However, in order to prevent data loss when CTL failure occurs, the storage sub-system 1 writes the same data in a duplicated manner to CACHE0 and CACHE1 in each CTL0 and CTL1, according to which data is made redundant.

In other words, the data transfer control unit 2010 of CTL0 20 writes the write data in duplicated manner to CACHE1 2121 of CTL1 (S1010). Next, the CPU0 2070 of CTL0 20 reports completion of write processing to HOST0 40 via the host communication control unit FE0 2000 of CTL0 20 (S1011). Lastly, the data transfer control unit 2010 of CTL0 20 performs destaging (process of writing data only stored in a cache which is a volatile memory to the HDD) of CACHE1 2021 of CTL0 20 at an appropriate timing (such as within a period of time when the number of processing of I/O accesses is small), executes writing of data to the HDD 500 (LU0) (S1012), and ends the write request processing (S1013).

If the write request is to be performed by the CTL1 21 (S1003: No), the data transfer control unit 2010 of CTL0 20 transfers the write command to the data transfer control unit 2110 of CTL1 21. The data transfer control unit 2110 stores the received write command to LM1 2161 (S1014). Since CPU1 2171 of CTL1 21 is in charge of the write request processing to LU5, the command is stored in the corresponding LM1 2161.

Next, the CPU1 2171 of CTL1 21 searches the LM1 2161 and confirms the received write command (S1015). Thereafter, the CPU1 2171 in charge of processing creates a DMA list and stores the same in LM1 2161 (S1016). Then, the CPU1 2171 activates FE0 2000 which is the host communication control unit of CTL0 20 (S1017).

Next, FE0 2000 which is the host communication control unit of CTL0 acquires the DMA list from LM 12161 of CTL1 21 (S1018). Then, the data transfer control unit 2010 of CTL0 20 receives the write data according to the DMA address in the DMA list and stores the same in CACHE1 2021 of CTL0 20 (S1019). Next, the data transfer control unit 2010 of CTL0 20 writes the write data in duplicated manner to CACHE1 2121 of CTL1 (S1020).

Then, FE0 2000 which is a host communication control unit of CTL0 20 notifies that data transfer is completed to CPU0 2170 of CTL1 21 (S1021). Thereafter, the data transfer control unit 2010 of CTL0 20 reports write processing complete from the CPU0 2170 of CTL1 21 via the FE0 2000 which is a host communication control unit of CTL0 20 to the HOST0 40 (S1022).

Finally, the data transfer control unit 2110 of CTL1 21 performs destaging of CACHE1 2121 of CTL1 21 at an appropriate timing, executes writing of data to the HDD 550 (LU5) (S1022), and ends the write request processing (S1024). The above-described access operation performed when a write request is received is illustrated via the solid line arrow of FIG. 9.

<I/0 Read Access Request (FIG. 9)>

Next, the process and operation performed when an I/O read access request (hereinafter referred to as read request) is received will be described with reference to FIG. 9. First, the HOST0 40 sends a read request via the network 42 to the storage sub-system 1. In storage sub-system 1, the FE0 2000 which is the host communication control unit of CTL0 20 receives the read command of the read request. Next, the CTL0 20 having received the read request confirms via the associated LU management table 60 whether the CPU in charge of processing of the read target LU is itself (CTL0) or not.

If the read request is to be processed by CTL0 20, that is, if the read request is related to LU0 500 in which the LU number 61 is “0” in the associated LU management table 60, CPU0 of CTL0 20 will perform the processing. Therefore, if the read request is related to LU0, CTL0 20 executes the processing.

If the read request is not to be performed by CTL0 20 (should be performed by CTL1 21), the data transfer control unit 2010 transfers the read command to CTL1 21 and the read process is performed in CTL1. In the example of FIG. 9, since CTL0 20 should perform the read processing, the data transfer control unit 2010 of CTL0 20 stores the read command in LM0 2060 of CTL0 20. Next, the CPU0 2070 of CTL0 20 searches the LM0 2060 and confirms the received read command

Next, the CPU0 2070 activates BE0 2040 which is the storage device communication control unit of CTL0 20. Thereafter, the BE0 2040 which is the storage device communication control unit of CTL0 20 acquires the DMA list from LM0 2060 of CTL0 20 (S1008). Further, based on the DMA address in the acquired DMA list, the data transfer control unit 2010 of CTL0 20 receives the read data from LU0 500 from BE0 2040 and stores the same in CACHE0 2020 of CTL0 20.

At this time, unlike the write request, the read data will not be stored in the cache of CTL1. There are two cache memories for LU0 access, which are CACHE0 (AREA03 of SLOT01) and CACHE1 (AREA13 of SLOT11), so that read data should be stored in the preferable cache based on load status (used state). Next, the CPU0 2070 of CTL0 20 creates a DMA list and stores the same in LM0 2060. Then, CPU0 2070 of CTL0 20 activates FE0 2000 which is a host communication control unit. Thereafter, FE0 2000 which is a host communication control unit of CTL0 acquires the DMA list from LM 2060.

Thereafter, the data transfer control unit 2010 of CTL0 20 transfers the read data to FE0 2000 which is the host communication control unit of CTL0 based on the DMA address in the DMA list, and FE0 2000 sends the data to the HOST0 40 via the network 42. The above-described access operation when a read request is received is shown by the dotted line arrow in FIG. 9.

<<Failure>>

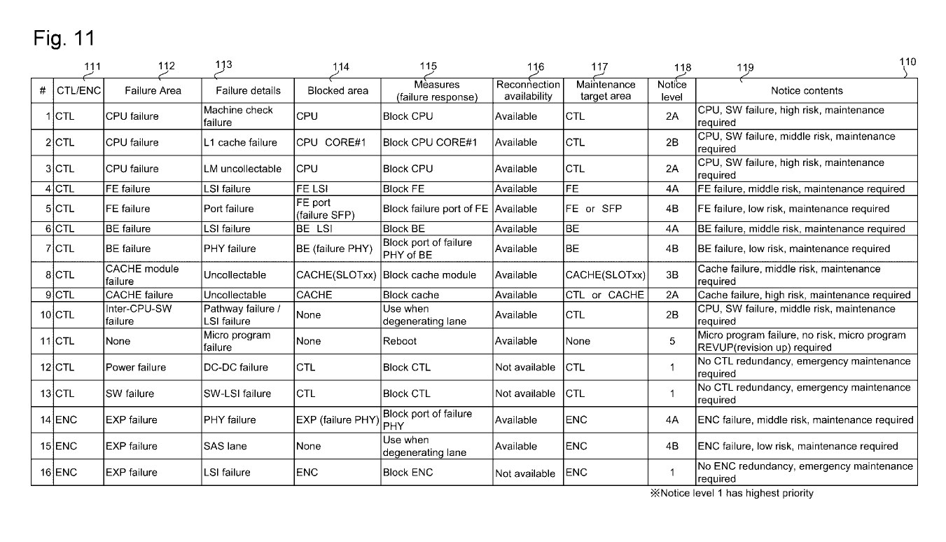

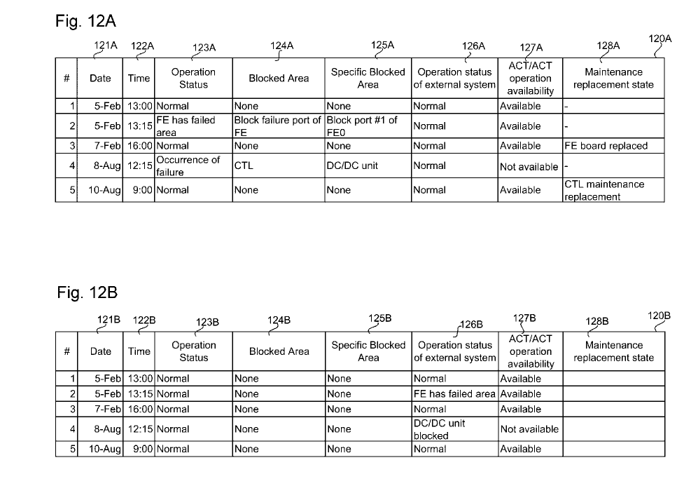

Now, the method of detecting failure and the method of performing isolation of a failure specified area and performing reconnection with a normal area according to the present invention will be described.

<Failure Management Tables (FIGS. 11-14)>

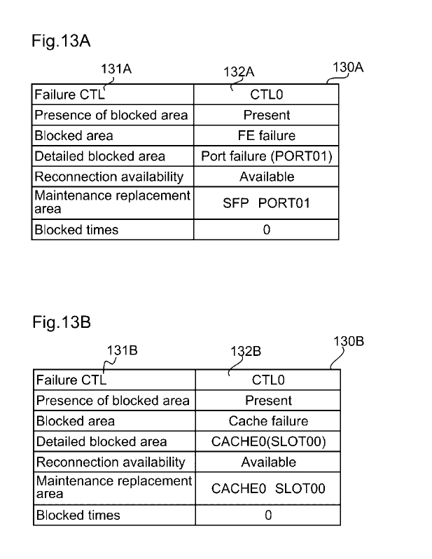

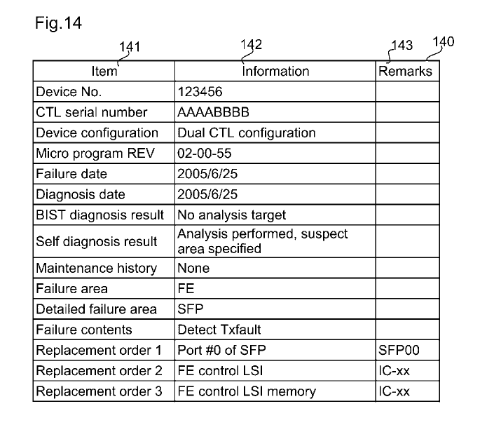

First, related management tables will be described with reference to FIGS. 11 through 14. FIG. 11 shows a configuration example of a failure management table. FIG. 12A shows a configuration example of a failure status table (controller unit 0). FIG. 12B shows a configuration example of a failure status table (controller unit 1). FIG. 13A is a view showing a configuration example of a configuration confirmation table when failure occurs in FE. FIG. 13B is a view showing a configuration example of a configuration confirmation table when failure occurs in a cache module. FIG. 14 is a view showing a configuration example of a replacement area table.

First, a failure management table which is a management table for referring to the specified contents of failure and to determine the area to be blocked or the re-connection availability will be described with reference to FIG. 11. The failure management table 110 is composed of a CTL/ENC 111 showing the location of occurrence of failure, a failure area 112 showing the type of the device in which failure has occurred, a failure detail 113 showing the detailed contents of failure, a blocked area 114 showing the area being blocked, a measure 115 showing the content of response to failure, a reconnection availability 116 for determining whether re-connection is possible or not after isolating the failure, a maintenance target area 117 for performing replacement with a maintenance component or the like, a notice level 118 which is the failure level to be notified to the management terminal 50 or the maintenance center 51, and a notice content 119 showing the notified contents of the failure.

For example, in CPU failure of #1, a failure information combining a notice level “2A” meaning that machine check failure has occurred during self diagnosis performed by the CPU itself and that the relevant CPU has been blocked and the contents of failure notice is notified from the CTL of the storage sub-system 1 to the management terminal 50 or the maintenance center 51. Similarly, it can be recognized that cache module failure of #8 is a notice level “3B” failure in that an uncollectable error has occurred and the cache module has been blocked.

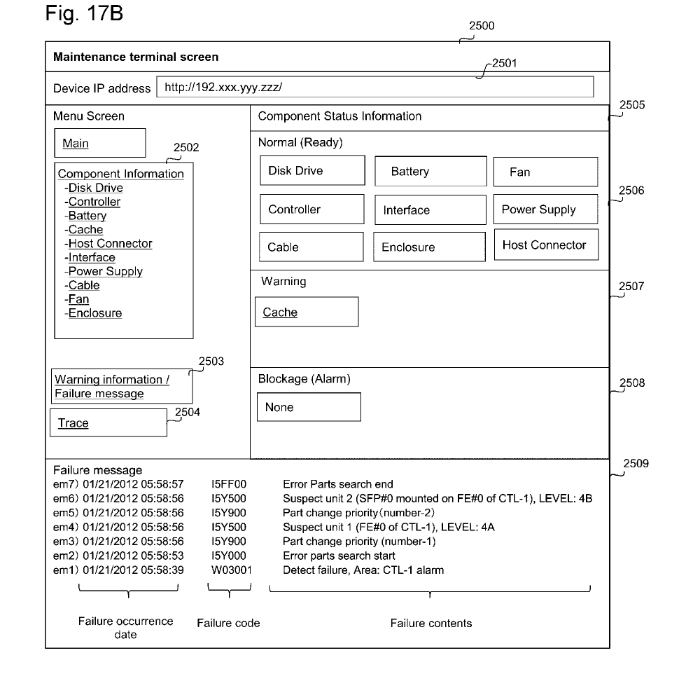

The smaller number of notice level shows the occurrence of a more serious failure, and the notice level “1” represents a fatal failure in which the priority of failure response is highest. Further, as described later (FIG. 17B), the contents of the notice level 118 and the notice contents 119 can be confirmed by the management terminal 50.

Next, a failure status table 120A or 120B which is a table for confirming the failure status of each CTL/ENC will be described with reference to FIG. 12. The failure status table is for determining whether or not active/active operation is enabled based on failure area. The failure status table is formed for each CTL 20/CTL 21. The configuration and contents of the failure status table in CTL0 of FIG. 12A are the same as FIG. 12B, so the present description will explain the failure status table 120A for CTL0 in FIG. 12A.

The failure status table 120A is composed of a failure occurrence date information 121A, a failure occurrence time information 122A, a failure state 123A, a blocked area 124A which is the information on the blocked device, a specific blocked area 125A which is the information for discriminating which section of the device is blocked, an operation status of external system 126A which is the information on the operation status of the external CTL (which is CTL1 if the internal system is CTL0), an ACT/ACT operation availability 127A for determining whether active/active operation is possible or not, and a maintenance replacement state 128A showing the contents of the maintenance performed in response to a past failure or during periodic maintenance.

For example, according to failure #2, it can be recognized from failure occurrence date information 121A and failure occurrence time information 122A that the failure has occurred at “February 5, 13:15” and from failure state 123A that the “failure area is included in FE”. Further, it can be recognized from blocked area 124A and specific blocked area 125A that “failure has occurred in port #1 of FE and that the port is blocked”. Based on the present failure, it can be recognized based on ACT/ACT operation availability 127A that active/active operation of storage sub-system 1 is enabled.

Similarly, for example, it can be recognized from the failure occurrence date information 121A, the failure occurrence time information 122A and the failure state 123A that the failure of #4 occurred at “August 8, 12:15” to “DC/DC unit of CTL0”, and from ACT/ACT operation availability 127A that active/active operation of storage sub-system 1 is not available.

Further, it is recognized based on maintenance replacement state 128A of #3 and #5 that maintenance and replacement of the FE board or the CTL unit have been performed in the past. The operation status of CTL0 can be confirmed by the external system operation status 126B in the failure status table 120B of CTL1, and the operation status of CTL1 can be confirmed in the external system operation status 126A in the failure status table 120A of CTL0. In other words, the operation status of CTL1 in normal operation is all “normal” as shown in the external system operation status 126A.

On the other hand, the operation status of CTL0 in which failure has occurred is recognized to be all “failure in FE unit” or “DC/DC unit blocked” as shown in the external system operation status 126B of #2 and #4. As described, by mutually referring to the failure status management table 120A and 120B via the aforementioned HOTLINE signal 2081 and the GPIO resister, it becomes possible for each CTL to mutually recognize the operation statuses, the occurrence of failure and the failure areas.

Next, a configuration confirmation table 130 that is referred to via a system control program during PWON (power on) or reboot of the storage sub-system 1 to determine whether to isolate the failure area will be described with reference to FIGS. 13A and 13B. The configuration confirmation tables 130A and 130B are composed of failure items 131A and 131B and failure contents 132A and 132B. Further, FIG. 13A is a configuration table 130A of a case where failure has occurred to the FE, wherein the CTL in which failure has occurred is CTL0, a blocked portion exists in the blocked area, and based on the blocked area of the failure item 131A and the failure contents 132A corresponding to the specific blocked area, it is recognized that the failure has occurred in PORT01 of FE unit and that only FE0 has been blocked.

Further, it can be seen from the table that the other PORT00 is normal and usable, so that it is possible to perform reconnection to CTL0 as reusable resource and that the maintenance replacement area is the SFP connector in PORT01. Since the whole CTL0 is not blocked, the blocked number remains 0.

The same description applies to the case where cache module failure occurs in FIG. 13B, and the area of the cache module in which failure has occurred can be specified. The CTL in which failure has occurred is CTL0, wherein the blocked location occurs when a blocked area exists, and based on the blocked area of failure item 131B and the failure contents 132B corresponding to the specific blocked area, it can be recognized that failure has occurred in SLOT00 of CACHE0 and that only CACHE0 is blocked. Further, it can be seen that the other cache module is normal and usable, so that it is possible to perform reconnection to CTL0 as reusable resource and that the maintenance replacement area is the SLOT00 of CACHE0. Since the whole CTL0 is not blocked, the blocked number remains 0.

Next, a replacement area table 140 having gathered failure information upon storing the details of the failure component specified via the self diagnosis executed during failure to the EEPROM or the like will be described with reference to FIG. 14. The replacement area table 140 is composed of a configuration item 141, a configuration information 142 and remarks 143 storing additional information. The replacement area table 140 stores basic information of the storage sub-system 1 such as the device number, the serial number of the CTL, the device configuration, and the revision of the system control program. Further, the replacement area table 140 stores a failure occurrence date, a self diagnosis execution date, a diagnosis result of BIST (Build in Self Test) executed when the device is started or restarted, diagnosis result via the self-diagnostic program activated when failure occurs or the like, the maintenance history, and the information on the failure area, specific failure area, failure contents and component replacement order.

According to the present example, a Txfault failure (transceiver unit transfer failure) has occurred to the SFP of the FE unit in Jun. 25, 2005, and self diagnosis is performed regarding the failure so as to specify the failure area. Based on the result of self diagnosis, a maintenance priority procedure is shown to replace components in the following priority order; SFP port number 0 20010 (FIG. 2), FE unit control LSI (host communication protocol chip) 20021, and FE unit control LSI memory (EEPROM) 20031.

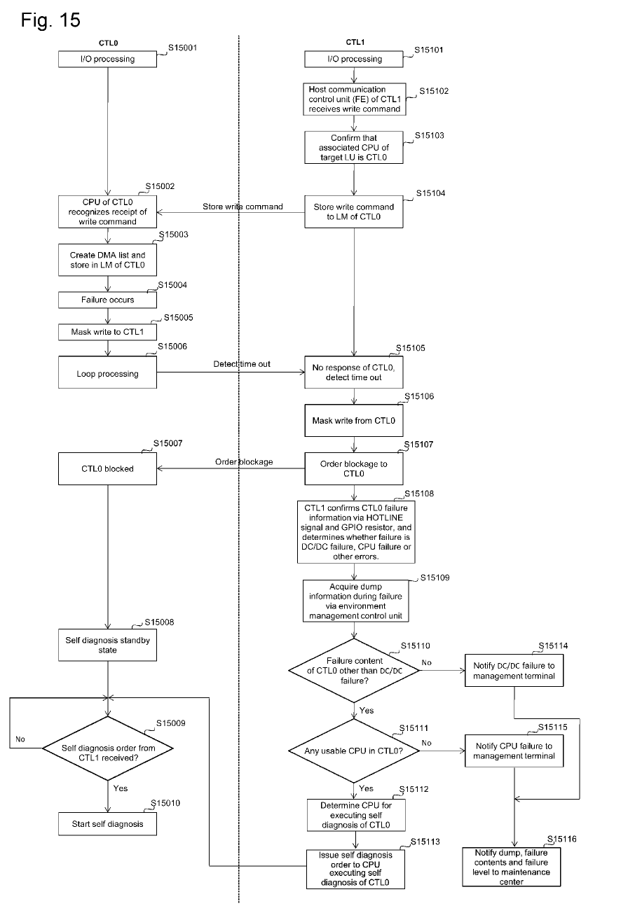

As described, based on the failure related management table including the failure management table 110, the failure status tables 120A and 120B, the configuration confirmation tables 130A and 130B and the replacement area table 140, it becomes possible to detect the failure, comprehend the contents of failure, the device in which failure has occurred and the area in which the failure has occurred in the interior thereof, and notify the failure information.

<Failure Response>

<Failure Detection / Self Diagnosis Order (FIGS. 15-17)>

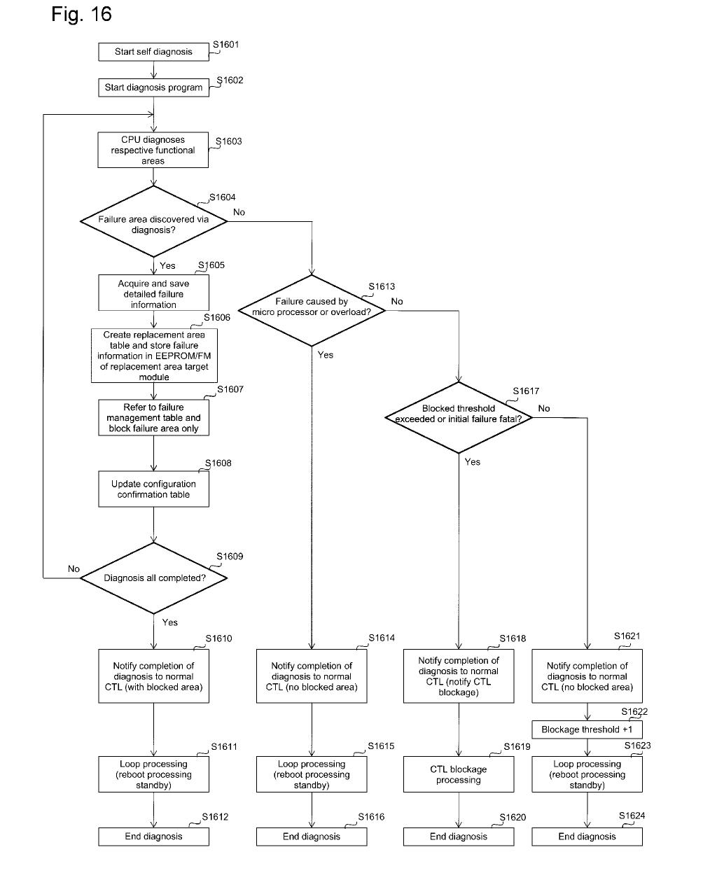

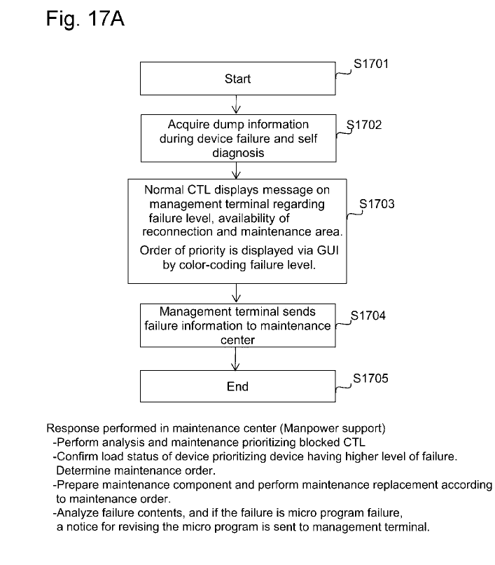

FIG. 15 is a flowchart showing the process of specifying the area in which failure has occurred. FIG. 16 is a flowchart showing the process of self diagnosis. FIG. 17 is a flowchart showing the maintenance and response based on failure notice levels. Next, the actual operation of failure detection, specification of failure area, isolation of the failure area and the reconnection of a normal area will be described with reference to FIGS. 15 through 17. In the description, it is assumed that a failure has occurred to CTL0 20 during an I/O write access request (hereinafter referred to as write request) to LU0 500 of the storage sub-system 1 from the HOST1 41.

At first, a write request from HOST1 41 is sent to CTL1 21 of the storage sub-system 1 (S15101). Next, the write request sent from the HOST1 41 is received by the host communication control unit FE0 2100 of CTL1 21, and CTL1 confirms reception of the write command of the write request (S15102). Then, the CTL1 21 identifies the CPU in charge of the write target LU via the associated LU management table 60. According to the present example, the request is a write request to LU0 500, so the CPU in charge of processing the same is recognized to be CPU0 2070 of CTL0 20 based on the associated LU management table 60 (S15103).

Next, the data transfer control unit 2110 of CTL1 21 controls the LM0 2060 connected to CPU0 2070 of CTL0 20 in charge of the process to store the write command (S15104). Thereafter, in the CTL0, the CPU0 2070 searches within the LM0 2060 and confirms receipt of the write command (S15002). Then, the CPU0 2070 creates a DMA list and stores the same in LM0 2060 of CTL0 20 (S15003).

After the storage processing is completed, a failure occurs, the cause of which being unclear at this point of time (S15004). Next, in order to prevent the abnormal CTL from influencing the processing of a different normal CTL, the abnormal CTL0 20 masks a write processing to the normal CTL1 21 and prohibits the transmission of access request (S15005). Then, the loop processing is executed and the processing is stopped (S15006).

On the other hand, the CTL1 21 awaits a receipt response regarding the write command sent to the CTL0 20 in step S15104. However, since the CTL0 20 masks the write command to CTL1 21and stops the processing in steps S15005 and S15006, a write command receipt response cannot be sent to the CTL1 21. Therefore, the CTL1 21 cannot receive the receipt response within a predetermined time after transmitting the write command, so the CTL1 21 detects time out and determines that some type of failure has occurred in the CTL0 20 (S15105).

Next, in order to prevent any requests from an abnormal CTL from affecting the processes of a normal CTL, the normal CTL1 21 masks the write command from the abnormal CTL0 20 and prohibits reception of an access request (S15106). Then, the CTL1 21 sends an order to block the abnormal CTL0 20 (S15107). The CTL0 20 having received the blockage order from CTL1 21 blocks itself (S15007), and enters a self diagnosis standby state (S15008). Next, the CTL0 20 determines whether a self diagnosis order has been issued from CTL1 21 or not (S15009). If the self diagnosis order is not issued (S15009: No), the abnormal CTL0 20 performs determination on whether a self diagnosis order has been issued or not until the self diagnosis order is issued from the CTL1 21.

The CTL1 21 having transmitted a blockage order to the CTL0 20 in step S15107 acquires the failure information using the environment management control unit 2180 of CTL1 21 so as to comprehend the failure status of CTL0. Actually, the failure information of CTL0 20 is acquired using the HOTLINE signal 2081 connecting the environment management control unit 2080 of CTL0 20 and the environment management control unit 2180 of CTL1 21 and the GPIO resister (not shown) within the environment management control unit. Further, the acquired failure information is analyzed so as to classify the failure into a power supply unit failure, a CPU failure or other failure, and comprehends the content of failure (S15108).

Next, CTL1 21 acquires a dump information during failure (failure transition information) from the environment management control unit 2180 (S15109). Next, CTL1 21 determines whether the contents of the failure having occurred in CTL0 20 is a failure of the DC/DC unit 2050 or DC/DC unit 2150 or not (S15110). If the contents of the failure having occurred in CTL0 20 is other than the failure of the power supply unit (S15110: Yes), the CTL1 21 determines whether there exists a CPU that can be used in the CTL0 (S15111). If there exists a CPU that can be used in CTL0 20 (S15111: Yes), CTL1 21 determines the CPU for performing self diagnosis in the CTL0 20 (S15112).

If the CPU for performing the determined self diagnosis is CPU0 2070, CTL1 21 issues a self diagnosis order to the CPU0 2070 ordering to execute self diagnosis of CTL0 20 (S15113). The CTL0 20 having received the self diagnosis order from CTL1 21 exits the loop processing of step S15009 and transits the status of CTL0 20 itself from self diagnosis standby state to self diagnosis start state, and starts self diagnosis (S15010). The contents of the self diagnosis processing will be described later (FIG. 16).

We will not return to step S15110. If the contents of failure of CTL0 20 is the failure of DC/DC unit 2050 or DC/DC unit 2150 in the determination of step S15110 (S15110: No), CTL1 21 issues a failure notice notifying that the contents of failure of CTL0 is a failure of the DC/DC unit 2050 or DC/DC unit 2150 to the management terminal 50, and sends the same together with the failure information such as the dump information, the contents of failure and the failure level (S15114). The management terminal 50 having received the failure notice transfers the failure information such as the dump information, the contents of failure and the failure level from CTL1 21 to the maintenance center 51 (S15116). The maintenance response processing in the maintenance center 51 having received the failure notice will be described later (FIG. 17).

Further, if there is no CPU that can be used in CTL0 20 by the determination in step S15111 (S15111: No), CTL1 21 issues a failure notice notifying that the contents of failure of CTL0 20 is in the CPU and in a level that cannot be self-diagnosed to the management terminal 50, and sends the same together with the failure information such as the dump information, the failure contents and the failure level (S15115). Lastly, the management terminal 50 sends the notice level and the failure information to the maintenance center 51 (S15116).

<Self Diagnosis (FIG. 16)>

Next, the contents of processing of self diagnosis will be described with reference to FIG. 16. The CPU0 2070 of CTL0 20 having received the self diagnosis order from CTL1 21 reads and starts the self-diagnostic program stored in EEPROM 2090 (S1602). Thereafter, the CPU0 2070 performs diagnosis of the operation status of each functional area (each device) and checks whether failure has occurred or not (S1603). Next, CPU0 2070 determines via self diagnosis processing whether a failure area has been discovered or not (S1604).

When a failure area has been discovered (S1604: Yes), CPU0 2070 acquires detailed information of failure of the failure area, and either stores the acquired detailed failure information in a nonvolatile memory such as the EEPROM 2090 or the SSD 2030, or transmits the same to CTL1 21, thereby saving and retaining the detailed failure information (S1605). Next, CPU0 2070 creates a replacement area table (FIG. 14) and stores the failure information in the EEPROM/flash memory (FM) or the like within the target module (device) of replacement (S1606).

Thereafter, CPU0 2070 refers to the failure management table 110 (FIG. 11) and blocks only the failure area (S1607). For example, in a PHY port failure of the BE unit shown in #7 of the failure management table 110, only the port where failure has occurred is blocked instead of blocking the whole BE unit. Next, CPU0 2070 updates the configuration confirmation table 130A since the failure is a CTL0 side failure (S1608). Thereafter, CPU0 2070 determines whether diagnosis of all functional areas have been completed or not (S1609). If diagnosis is not completed (S1609: No), CPU0 2070 returns to the procedure of step S1603 and re-executes the processes of steps S1603 and thereafter.

If all diagnosis is completed (S1609: Yes), CPU0 2070 executes step S1610. In step S1610, CPU0 2070 notifies the completion of diagnosis in CTL0 20 and the existence of a blocked area to CTL1 21 in normal operation status (S1610), executes the loop processing and awaits execution of a reboot processing (S1611).

If a failure area is not found in the diagnosis result determination of step S1604 (S1604: No), CPU0 2070 determines whether the cause of failure is a failure of a micro program such as a system control program or an overloaded state of the storage sub-system 1 (S1613). The determination on whether the storage sub-system 1 is in overloaded state or not is performed based on the load of each device (each functional area) in the load status management table 80 of FIG. 8 or the cache memory capacity allocation ratio in the cache management table 70 of FIG. 7.

If CPU0 2070 determines that the cause of failure is a micro program defect or overload (S1613: Yes), CPU0 2070 notifies CTL1 21 in a normal operation status that the diagnosis of CTL0 20 is completed and that no blocked area exists (S1614), executes a loop processing and awaits execution of a reboot processing (S1615).

If CPU0 2070 determines that the cause of failure is neither micro program defect or overload (S1613: No), the CPU0 2070 refers to failure information in the failure status table 120A or the configuration confirmation tables 130A and 130B or the failure management table 110 to determine whether a threshold of blocked number is exceeded or the initial failure is a fatal failure (notice level “1”) (S1617). If CPU0 2070 determines that the threshold is exceeded or the failure is a fatal failure (S1617: Yes), CPU0 2070 notifies CTL1 21 in the normal operation status that the diagnosis in CTL0 20 is completed and the a blockage processing of the whole CTL0 20 is executed (S1618).

Next, CPU0 2070 executes a blockage processing to the whole CTL0 20 to block the whole CTL0 20 (S1619), and ends the processing (S1620). If CPU0 2070 determines that the failure is not caused by exceeding the threshold or by fatal failure (S1617: No), CPU0 2070 notifies CTL1 21 in normal operation status that the diagnosis in CTL0 20 is completed and that no blocked area exists (S1621). Then, the blockage threshold is incremented (S1622) and a loop processing is executed to await execution of a reboot processing (S1623).

Based on the above-described process, it becomes possible to detect failure, the contents of failure, the device in which failure has occurred, the area in which failure has occurred within the device, and to notify the failure information. Furthermore, since it is possible to isolate only the failure resource, not all the resources in which failure has partially occurred is blocked, and the usable normal resource can be reused in the storage sub-system 1, so that the deterioration of performance can be prevented.

<Maintenance Response>

Next, a maintenance response via a failure notice level will be described with reference to FIGS. 17A and 17B. First, the normal CTL1 21 acquires the dump information during occurrence of failure and self diagnosis of the storage sub-system 1 (S1702 of FIG. 17A). Thereafter, the environment management control unit 2180 of CTL1 21 sends the failure information such as the failure level, the availability of reconnection and the maintenance area to the management terminal 50 coupled to the storage sub-system 1 via a LAN. The management terminal 50 having received the failure information displays a message on the management terminal screen 2500 as shown in FIG. 17B.

The message can be displayed on the management terminal screen 2500 by the maintenance crew or the user entering the IP address of the device in a WEB browser 2501 (S1703). Actually, when the maintenance crew or the user enters the IP address of the device, which is “192.xxx.yyy.zzz” in the WEB browser 2501, a component status information 2505 and a failure message 2509 or the like are displayed on the management terminal screen 2500.

Moreover, the screen can be color-coded according to the failure level, and the priority order or the like can be displayed via GUI (Graphic User Interface) and for example, a normal state (ready) 2506 can be shown in “green”, a warning state (warning) 2507 can be “yellow” and a blocked state (alarm) 2508 can be “red”. The warning state (warning) 2507 assumes that after the resource in which failure has occurred is specified, only the resource not having failure is reconnected. In the example of FIG. 17B, the “cache memory” corresponds to the resource in reconnected state of the resource having no failure after the resource in which failure has occurred is specified.

Further, the details of the operation status of each component (resource) can be displayed by selecting a component information button 2502 in a menu screen. Further, the detailed contents of the warning information/failure message can be displayed as a failure message 2509, for example, by selecting the warning information and the failure message button 2503. Moreover, by selecting a trace button 2504, it becomes possible to search the operation status and the failure state of the storage sub-system 1.

Further, it can be recognized from the failure message 2509 that a new failure has occurred to the CTL1 21 other than the cache memory. In the failure message 2509, the contents of the aforementioned failure management table 110 (FIG. 11), the failure status tables 120A and 120B (FIGS. 12A and 12B), the configuration confirmation table 130 (FIG. 13) and the replacement area table 140 (FIG. 14) are displayed. Actually, the contents include the failure occurrence date and time 121B and 122B managed via the failure status table 120B, the notice level 118 of the failure management table 110, the failure area, the blocked area and the detailed block area managed via the failure confirmation table 120 or the configuration confirmation table 130, and the replacement order of components of the replacement area table 140.

Actually, the failure having occurred at CTL1 at 5:58:39 on Jan. 21, 2012 is detected by CPU0 2170 of CTL1 21 of the storage sub-system 1, the search of the failure location is started at 5:58:53 of the same date, and a failure of a “4A” notice level 118 is specified in the first priority suspected unit “FE0 of CTL1” at 5:8:56 of the same date. At the same time, a failure of a “4B” notice level 118 is specified in the second priority suspected unit “SFP0 mounted in FE0 of CTL1”.

Lastly, the management terminal 50 sends the above-mentioned failure information to the maintenance center 51 (S1704). The maintenance center 51 having received the notice of occurrence of failure and failure information responds in the following manner.

(M1) Perform failure analysis and maintenance prioritizing the CTL in which the whole CTL is blocked.

(M2) Confirm the load status of the device prioritizing the device having higher level of failure. Determine the maintenance order for performing maintenance.

(M3) Prepare maintenance components and perform maintenance and replacement based on the order of maintenance.

(M4) Based on the analysis of the contents of failure, if the failure is a micro program defect, the program is updated to a program having solved the defect (revised version), and the notice of revision is sent to the management terminal 50.

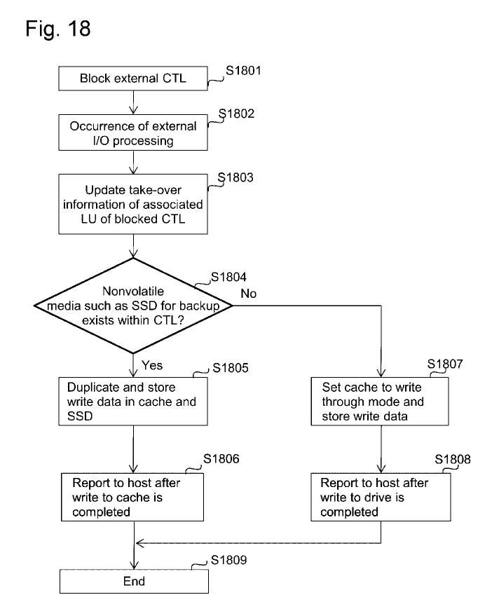

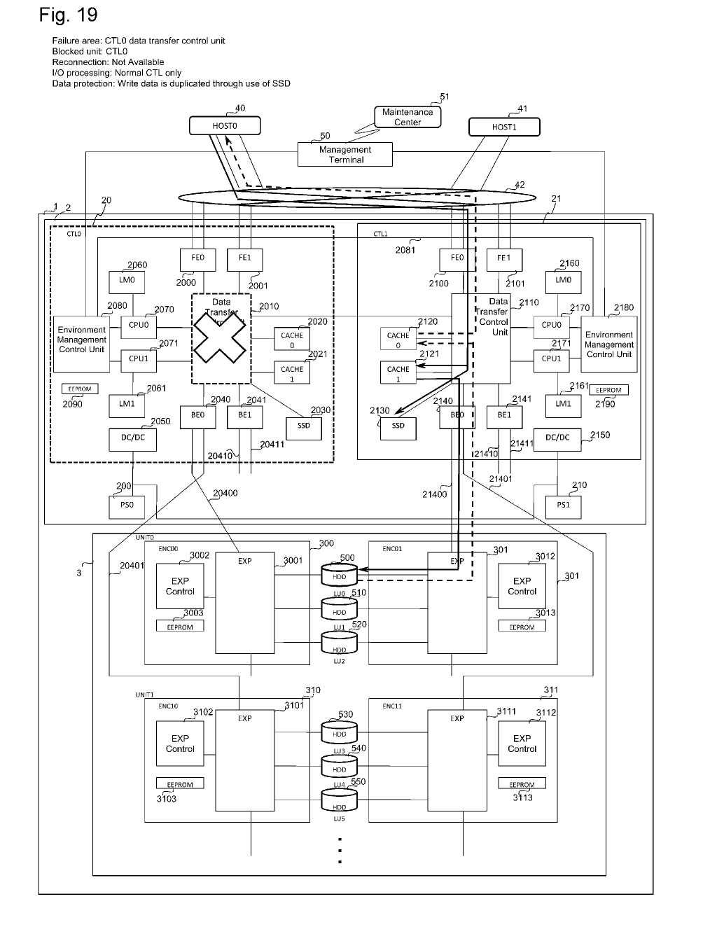

As described, it is possible to improve the maintenance performance by notifying failure information and performing maintenance response with respect to the failure.

<I/0 Access Processing During Failure (FIGS. 18, 19)>

FIG. 18 shows the I/O access processing in a normal controller unit during which the abnormal controller unit is blocked. FIG. 19 shows a process of reconnecting a normal resource to the system when failure occurs to the data transfer control unit.

Next, the processing and action performed in response to an I/O access request from a host when the external CTL is blocked will be described with reference to FIGS. 18 and 19. In the present example, it is assumed that the whole CTL0 20 has been blocked by the failure of the data transfer control unit 2010 of CTL0 20 as shown in FIG. 19.

At first, CTL1 21 which is the internal controller unit (hereinafter referred to as the internal system) recognizes based on the failure information from the environment management control unit 2180 that CTL0 20 of an external controller unit (hereinafter referred to as the external system) is blocked (S1801). Next, an I/O write access request (hereinafter referred to as write request) is generated to the HDD 500 (LU0) of the disk housing 3 from the HOST0 40 regarding the external CTL0 20 in which failure has occurred (S1802). Based on the associated LU management table 60, CPU0 2070 of CTL0 20 is in charge of the write request output to LU0, but since the whole CTL0 20 is in blocked state by failure, the process cannot be executed.

Therefore, the normal internal CTL1 21 takes over the processing. Actually, the associated CTL number 62 of the LU in which the respective LU numbers 61 to be processed via CTL0 in the associated LU management table 60 is “0”, “2”, “4” and “6” is changed from “CTL0” to “CTL1”. Regarding associated CPU number 63 and associated core number 64, the associated CPU and the associated core are changed via CTL1 21 by comprehending the load status of the load status management table 80 (FIG. 8) so as to equalize the load. Based on the changed status information, CTL1 21 updates the associated LU management table 60.

Similarly regarding cache, CTL1 21 updates the cache management table 70 so that the load is equalized via the load status of the load status management table 80. Actually, CTL1 21 updates the cache management table 70 so as to change the allocation of AREA03, AREA04, AREA13 and AREA14 allocated to LU0, LU2, LU4 and LU6 to CACHE0 2120 and CACHE1 2121 of CTL0 20 (S1803).

Next, the internal CTL1 21 determines whether or not a nonvolatile storage device such as an SSD for backup capable of storing a large amount of data exists in the interior thereof (S1804). When an SSD exists (S1804: Yes), CTL1 21 leaves the write mode to the cache to “write back mode” and writes the write data into CACHE1 2121 and SSD 2130 so as to duplicate the data and maintain data security (S1805). After completing writing of data to CACHE1 2121 and SSD 2130, CTL1 21 notifies that write processing is completed to HOST0 40 (S1806).

If SSD does not exist (S1804: No), CTL1 21 changes the write mode to the cache from the “write back mode” to a “write through mode” and writes in the write data to CACHE1 2121 and HDD 500 (LU0) (S1807). After completing writing of data to HDD 500, a write complete report is notified to the HOST0 40 (S1808). The flow of write data is shown by the solid line arrow in FIG. 19. Similarly, when a read request is received, CTL1 21 reads the data via the path shown by the dotted line arrow and sends the same to HOST0 40.

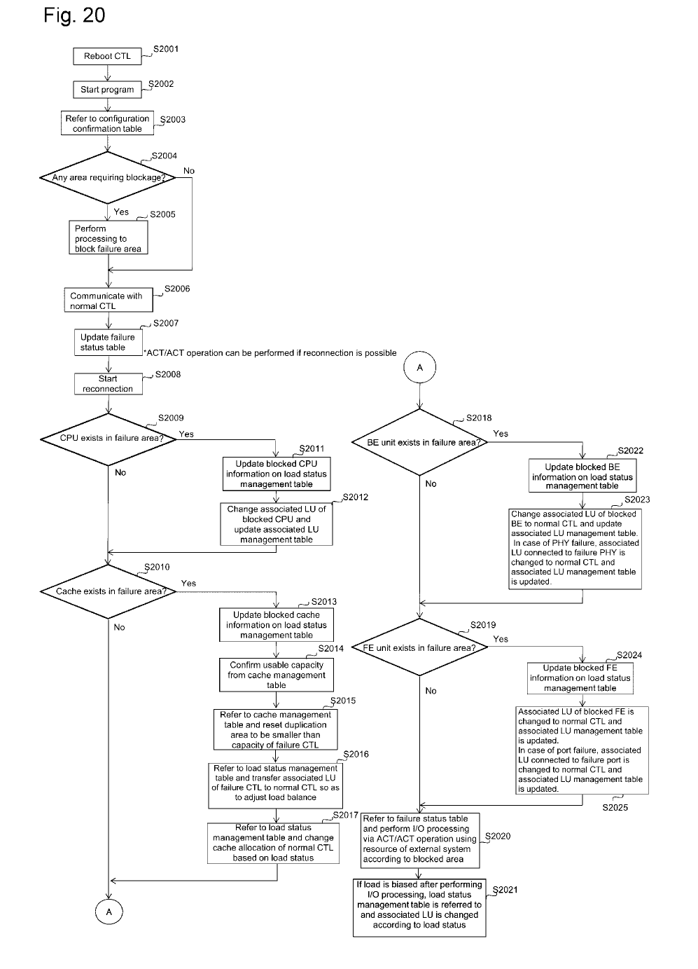

As described, even if the whole CTL of a single system is blocked by failure and cannot be used to realize a redundant configuration, the I/O processing from the host can be continued by isolating the failure CTL and taking over the role by the other CTL.

<Separation of Failure Area and Reconnection Processing (FIG. 20)>

FIG. 20 is a flowchart showing the process of reconnection to the system of an isolated normal resource. Next, an example of the process of reconnecting of the isolated normal resource to the system will be described with reference to FIG. 20.

As shown in FIG. 16, CTL0 20 after performing self diagnosis is in a reboot processing standby state, and all I/O access requests from the host is processed in CTL1 21 as shown in FIG. 18. Therefore, the processing ability of storage sub-system 1 is deteriorated compared to the normal operation status. Therefore, CTL0 20 is restarted to enter an operation status and to take over the processing in order to recover the processing ability of the storage sub-system 1. CTL1 21 orders starting of the reboot processing of CTL0 20 (S2001). The CPU0 2070 reads a device startup program for restarting the CTL0 20 (hereinafter referred to as restarting program) from the EEPROM 2090 and executes the same (S2002). The restarting program refers to the configuration confirmation table 130A of the CTL0 (S2003).

The restarting program determines whether an area to be blocked exists or not

(S2004). If an area that must be blocked exists (S2004: Yes), the restarting program executes the processing to block the failure area of step S2005 and then performs S2006. If there is no area that must be blocked (S2004: No), the restarting program executes step S2006 immediately.

Next, the restarting program performs communication with a CTL1 21 in normal state, and notifies that the restart of CTL0 20 is started to CTL1 21 (S2006). Thereafter, the restarting program reads the detailed failure information saved and retained in step S1605 of FIG.16 from the CTL1 21 or the internal SSD 2030 or the EEPROM 2090 (S2007).

Thereafter, the restarting program uses the read detailed failure information and updates the failure status table 120A (S2007). If the whole CTL0 can be reconnected via the updated failure status table 120A, the storage sub-system 1 is capable of performing an active/active operation.

Next, the restarting program confirms the updated failure status table 120A or the configuration confirmation table 130A or 130B, and starts the reconnection processing (S2008). Then, the restarting program determines whether a CPU exists in the failure area or not (S2009). If a CPU exists within the failure area (S2009: Yes), the restarting program updates the load status management table 80 (FIG. 8) via the blocked CPU information (S2011), changes the information of the LU associated to the blocked CPU, and updates the associated LU management table (S2012).

If a CPU does not exist within the failure area (S2009: No), the restarting program determines whether a cache unit exists within the failure area (S2010). If a cache unit exists within the failure area (S2010: Yes), the restarting program updates the blocked cache unit information on the load status management table 80 (S2013), and confirms the cache memory capacity that can be used in the failure CTL side (CTL0) by the cache management table 70 (FIG. 7) (S2014). Next, the restarting program refers to the cache management table 70, and resets the cache management table 70 so that the allocation capacity to the duplicated area becomes equal to or smaller than the cache memory capacity usable by the failure CTL0 (S2015).

Then, the restarting program refers to the load status management table 80, and the associated LU of the failure CTL0 is transferred to the normal CTL1 so as to adjust the load balance among CTLs (S2016). Next, the restarting program refers to the load status management table 80 and changes the allocation capacity of the cache on the normal CTL1 side based on the load status (S2017). If there is no cache unit in the failure area (S2010: No), the restarting program determines whether a BE unit exists in the failure area or not (S2018).

If a BE unit exists in the failure area (S2018: Yes), the restarting program updates the blocked BE unit information on the load status management table 80 (S2022). Then, the restarting program changes the associated LU of the blocked BE unit to the normal CTL1 and updates the associated LU management table 60 (FIG. 6). If the failure is a PHY port failure, the restarting program changes the associated LU coupled to the relevant PHY port to the normal CTL1 and updates the associated LU management table 60 (S2023).

When there is no BE unit existing in the failure area (S2018: No), the restarting program determines whether an FE unit exists in the failure area or not (S2019). If an FE unit exists in the failure area (S2019: Yes), the restarting program updates the blocked FE unit information on the load status management table 80 (S2024). Then, the restarting program changes the associated LU of the blocked FE unit to the normal CTL1, and updates the associated LU management table 60. If failure occurs in the port, the restarting program changes the associated LU coupled to the relevant port to the normal CTL1, and updates the associated LU management table 60 (S2025).

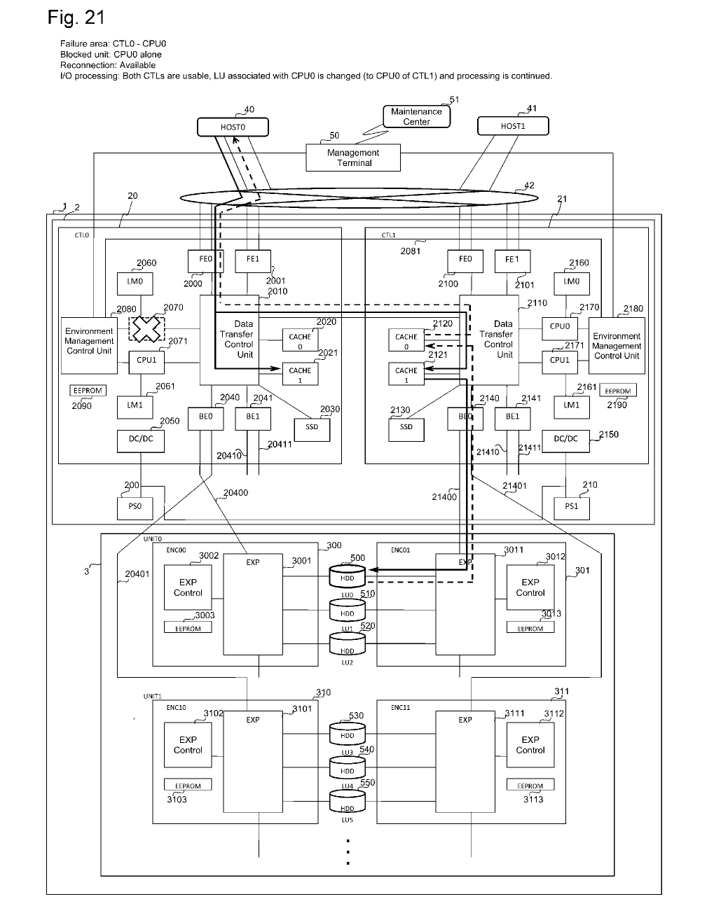

If there is no FE unit in the failure area (S2018: No), or after executing step S2025, the restarting program refers to the failure status table 120A, and performs an I/O access processing via an active/active operation using resources in the external system according to the blocked area (S2020). If load is biased after performing the I/O access processing, the restarting program refers to the load status management table 80 and changes the associated LU based on the load status (S2021).

<Reconnection corresponding to Failure Area and I/O Access Processing (FIGS. 21-24)>

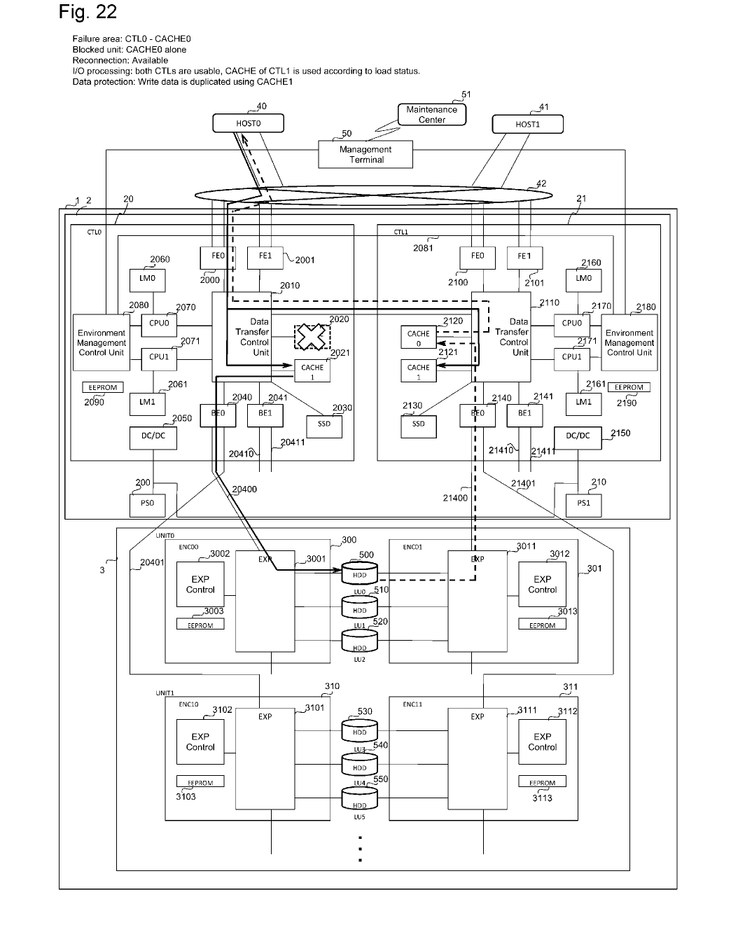

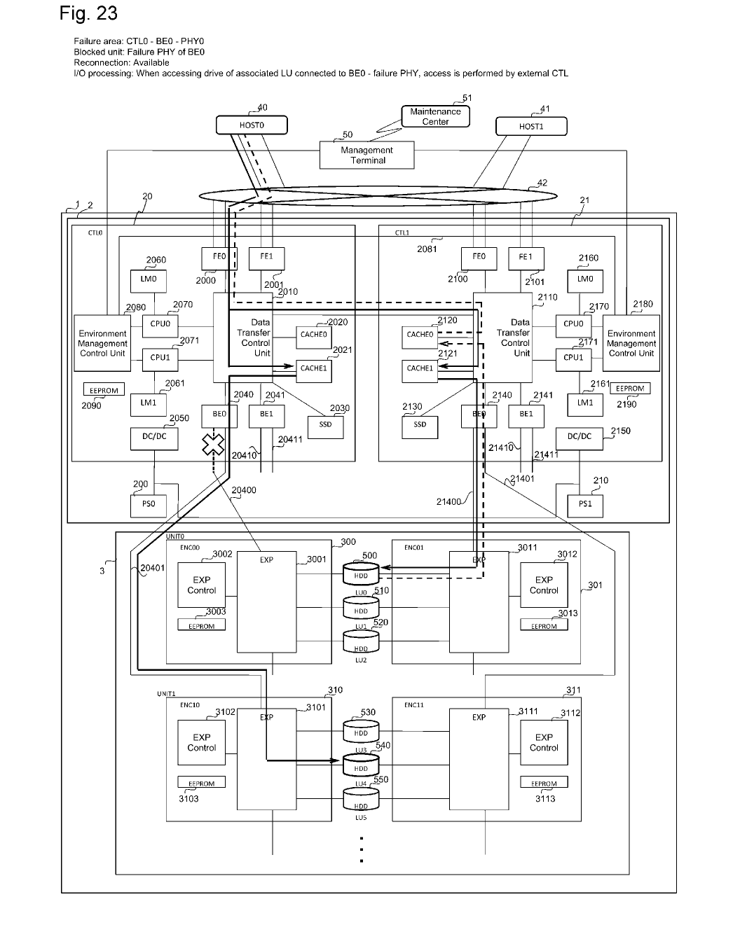

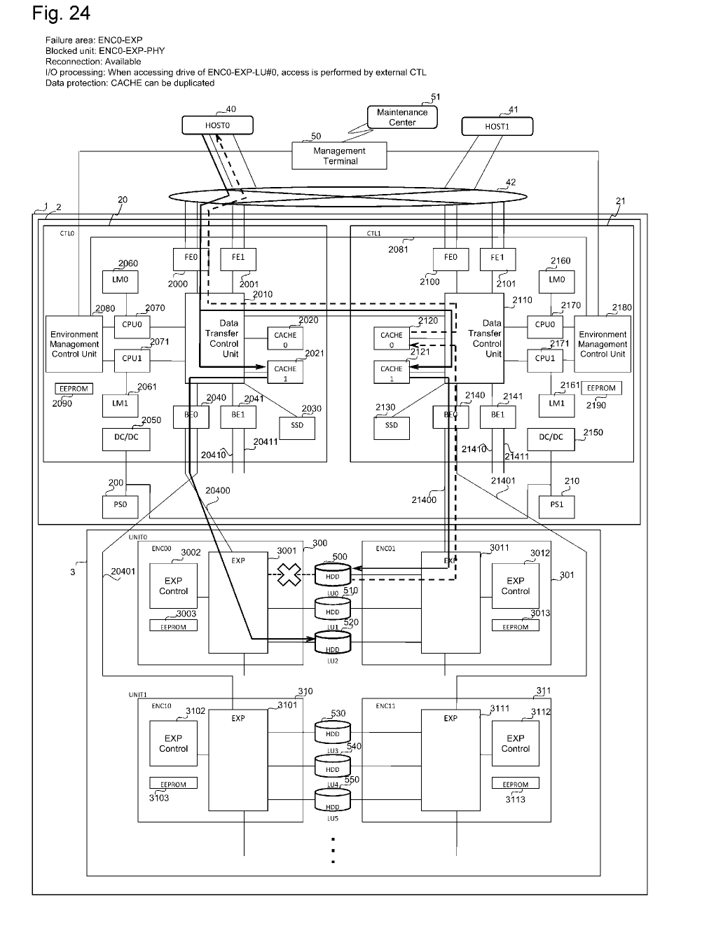

Next, an embodiment of the reconnection corresponding to the failure area and the I/O access processing will be described with reference to FIGS. 21 through 24. FIG. 21 is a view showing the process for reconnecting a normal resource to the system when failure occurs to the CPU. FIG. 22 is a view showing the process for reconnecting a normal resource to the system when failure occurs to the cache memory. FIG. 23 is a view showing the process for reconnecting a normal resource to the system when failure occurs to the BE. FIG. 24 is a view showing the process for reconnecting a normal resource to the system when failure occurs to the expander.

<CPU Failure (FIG. 21)>

The reconnection processing and the I/O access processing when failure occurs to the whole CPU0 2070 of CTL0 20 will be described with reference to FIG. 21. According to the contents of failure of the present example, the failure area is the CPU0 2070 of CTL0 20, the unit of blockage is the whole CPU0, and the notice level of the failure is “2A” as shown in #1 or #3 of the failure management table 110. Further, the reconnection of a normal resource and the I/O access processing via both CTL units is enabled, so that the LU associated to CPU0 2070 of CTL0 20 is changed to CPU0 of CTL1, and the processing is continued.

When failure is detected in CPU0 2070 of CTL0 20, the storage sub-system 1 executes the process of specifying the area in which failure has occurred according to FIG. 15, blocks the failure CTL0 20 and enters a self diagnosis standby state. Thereafter, the self diagnosis processing of FIG. 16 is executed based on the order from the normal CTL1 21. In the self diagnosis processing, the detailed failure information of step S1605 is saved and retained, the replacement area table is created and the failure information is stored in the replacement component target module, the failure area is blocked based on the failure management table 110, and the configuration confirmation table 130A is updated.

After completing self diagnosis, the failure CTL0 20 moves onto a reboot processing standby state, and the normal CPU1 2071 executes the reconnection processing of FIG. 20. At first, the normal CPU1 2071 executes the restarting program and confirms the area required to be blocked by referring to the configuration confirmation table 130A. In the present example, the CPU0 2070 is blocked, the failure status table 120A is updated by the detailed failure information, and the reconnection of the whole CTL0 in blocked state to the storage sub-system 1 is started.

Next, the CPU1 2071 updates the load status management table 80 by the information on the blocked CPU0 2070, changes the information on the LU (LU0 and LU2) that the blocked CPU0 2070 was in charge of, and updates the associated LU management table 60.

Next, the CPU1 2071 refers to the failure status table 120A, and performs the I/O access processing via active/active operation using resources of the external system in response to the blocked area. If load is biased after performing the I/O access processing, CPU1 2071 refers to the load status management table 80 and changes the associated LU based on the load status. Actually in CPU0 2070, as can be seen from the load status management table 80, the status of load of CORE0 and CORE1 is as high as 80%, and load of the associated LU0 is as high as 90% and the load of LU2 is as high as 80%, so it can be recognized that a large amount of I/O accesses have been processed.

The CPU0 2170 of CTL1 21 has also processed a large amount of I/O accessed similar to CPU0 2070. If CPU0 2170 of CTL1 21 takes over the processing of CPU0 2070 of CTL0 20, it will become overloaded, and the processing performance of the storage sub-system 1 will be deteriorated. Thus, the processing is dispersed and taken over by CPU1 2071 of CTL0 20 and CPU1 2171 of CTL1 21 having relatively small loads. In other words, the CPU in charge of LU0 is changed to CPU1 2171 of CTL1 21 and the CPU in charge of LU2 is changed to CPU1 2071 of CTL0 20, by which the load is distributed.

In the I/O access that has occurred after the change of associated LU, such as the access to LU0 500 from the HOST0 40 via CTL0 20, the access request is transferred to CTL1 21 and the process is performed in CPU1 2171 as shown in the write request (solid line arrow) and the read request (dotted line arrow) of FIG. 21.

Based on the configuration and the operation described above, self diagnosis can be performed to the area blocked after failure has occurred and isolated from the storage sub-system, and based on the self diagnosis, the specific area within the failure area can be specified. Furthermore, the specified failure area can be isolated, and the whole controller unit CTL0 which is an area capable of being reconnected to the storage sub-system can be returned to the operation status again, according to which the risk of deterioration of performance or system overflow can be reduced until maintenance and replacement is performed.

The present embodiment has illustrated an example in which a fatal failure has occurred in the whole CPU0 2070 and can no longer be used, but even if failure occurs to one of the cores of the two cores within the CPU or if failure occurs to the LM connected to the core, the self diagnosis according to the present invention can be performed to specify the failure area, perform isolation and reconnection, so as to isolate the failure core and reconnect the normal core.

<Cache Memory Failure (FIG. 22)>

The reconnection processing and the I/O access processing when failure has occurred to CACHE0 2020 of CTL0 20 will be described with reference to FIG. 22. According to the contents of failure of this example, the failure area is CACHE0 2020 of CTL0 and the blocked unit is the whole CACHE0, which is a failure of notice level “2A” of #9 in the failure management table 110. Further, it is possible to perform reconnection of a normal resource and to perform I/O access processing of both CTL units, so that CACHE0 2120 or CACHE1 2121 of CTL1 21 can be used according to the load status. Further, the duplicated state of write data can be maintained via CACHE1 2021 to realize data protection.

A process similar to CPU failure mentioned earlier is performed for cache failure, wherein by updating the various management tables, the whole controller unit CTL0 can be recovered to the operation status, and the risk of deterioration of system performance or system overflow can be reduced until maintenance and replacement is performed.

The present embodiment has illustrated an example in which a fatal failure has occurred in the whole CACHE0 2020 and can no longer be used, but even in the case of a cache module failure of notice level “3B” of #8 of the failure management table 110, only the module in which failure has occurred can be isolated to perform reconnection of the normal module. In other words, when failure occurs to SLOT00 of CACHE0 2020 of CTL0 20 as in the load status management table 80 of FIG. 8 and blockage is performed, the allocation capacity of the reconnected SLOT01 and the normal CACHE1 2021 should be increased to compensate for the capacity 2GB allocated to SLOT00. When an I/O write access request (solid line arrow) from the host to LU0 500 is issued, the processing is performed in CTL0 20, and when a read request (dotted line arrow) is issued, the processing is performed in CTL1 so as to planarize the load distribution and cache use.

<BE Failure (FIG. 23)>

The reconnection processing and the I/O access processing when failure has occurred to the BE unit of CTL0 20 will be described with reference to FIG. 23. According to the contents of failure of this example, the failure area is port PHY0 20405 of BE0 2040 of CTL0 20, and the blocked unit is the failure port PHY0 20405, which is a failure of notice level “4W of #7 in the failure management table 110.

Further, it is possible to perform reconnection of a normal resource and to perform I/O access processing of both CTL units, so that the access to the HDD of the associated LU connected to the failure port PHY0 20405 is performed via CTL1 21 of the external system. In other words, the access to LU0 500 is performed via CTL1 21 and EXP 3011 of ENC01 301. The access to LU4 540 is performed via CTL0 20 and EXP 3101 of ENC10 310.

Similar to the CPU failure and the cache failure, the port PHY failure of the BE unit can also isolate the failure area and return the whole controller unit CTL0 to the operation status so as to reduce the risk of performance deterioration or system overflow until maintenance and replacement is performed.

According to the present embodiment, the isolation and reconnection processing when failure has occurred in port PHY of the BE unit has been illustrated, but the same processing as the port PHY processing can be performed when failure has occurred in BE unit LSI (storage device control protocol chip 20420) having a notice level “4A” according to #6 in the failure management table.

Further, a similar processing as the failure of the BE unit can be performed when failure has occurred to the FE unit such as the FE unit LSI (host communication protocol chip 20021) failure having a notice level “4A” according to #4 or when failure has occurred to the FE unit port failure having a notice level “4B” according to #5 of the failure management table 110

<EXP failure (FIG. 24)>

FIG. 24 illustrates a reconnection processing and an I/O access processing when failure has occurred in a connection line connecting the EXP 3001 within ENC00 and LU0 (HDD 500). According to the present example, the failure area is EXP 3001 of ENC00 in area 20405, the blocked unit is the failure port PHY, which is a failure having a notice level “4A” according to #14 in the failure management table 110. Further, it is possible to perform reconnection to a normal resource and to perform I/O access processing in both CTL units, and the access to the HDD of the associated LU connected to the failure port PHY is performed via the CTL1 21 of the external system.

The access to LU0 500 is performed via CTL1 21 and EXP 3011 of ENC01 301. Further, the access to LU2 520 is performed via CTL0 and EXP 3001 of ENC00 300. Even when failure exists, the data is duplicated via the cache so that data protection can be continued.

As described, even when failure occurs in EXP 3001, the specific failure area within EXP 3001, which in the present example is the port PHY, can be specified and isolated, according to which the resource of EXP 3001 can be used in continuation. In addition, the CTL0 20 can be reconnected to the storage sub-system 1 and used, so that the risk of system performance deterioration and system overload can be reduced until maintenance and replacement is performed.

According to the present example, if the failure is a SAS lane (connection line) failure (notice level “4B”) which is the same EXP failure described regarding port PHY failure having a notice level “4A” according to #14 in the failure management table 110, it becomes possible to reconnect and reuse the EXP, ENC and CTL by de-generating a lane (prohibiting usage of the failure lane), so that the system resources can be utilized efficiently.

According to the above-described configuration and operation, self diagnosis can be performed to the area blocked after occurrence of failure and isolated from the storage sub-system, and the specific area of the failure area can be specified by self diagnosis. Furthermore, by isolating the specified failure area and returning the whole controller unit which is an area that can be reconnected to the storage sub-system to the operation status again, it becomes possible to effectively utilize resources and to reduce the risk of system performance deterioration, system overload and data loss before maintenance and replacement is performed.

### INDUSTRIAL APPLICABILITY

The present invention can be applied to information processing devices such as large-scale computers, general-purpose computers and servers, and to storage devices such as storage systems.

### REFERENCE SIGNS LIST

1 Storage sub-system

2 Controller housing

3 Disk housing

3A, 3B Disk unit

20, 21 Controller unit

40, 41 Host

42 Network

50 Management terminal

51 Maintenance center

60 Associated LU management table

61 LU number

62 Associated CTL number

63 Associated CPU number

64 Associated CORE number

65 Drive unit number

66 LU status

70 Cache allocation management table

71 CTL type

72 Cache number

73 Slot number

74 Area number

75 Usage

76 Total capacity

77 Allocation capacity

78 Allocation rate

80 Resource load status management table

81 CTL type

82 Area

83 Specific area

84 Load

8 Operation state

86 Capacity

87 Failure response

110 Failure management table

111 CTL/ENC classification

112 Failure area

113 Detailed failure

114 Blocked area

115 Failure response

116 Availability of reconnection

117 Maintenance target area

118 Notice level

119 Notice contents

120A, 120B Failure status table

121A, 121B Date

122A, 122B Time

123A, 123B Operation state

124A, 124B Blocked area

125A, 125B Detail blocked area

126A, 126B Operation state of external system

127A, 127B ACT/ACT operation availability

128A, 128B Maintenance and replacement state

130A, 130B Configuration confirmation table

131A, 131B Failure occurrence confirmation item

132A, 132B Failure contents

140 Replacement area table

141 Item

142 Information

143 Remarks

200, 210 Power supply unit

207A, 207B CPU

300, 301, 310, 311 ENC

500, 510, 520, 530, 540, 550 HDD

2000, 2001, 2100, 2101 FE

2010,2110 Data transfer control unit

2011 Inter-controller dedicated bus

2020, 2021, 2120, 2121 Cache memory

2030, 2130 SSD

2040, 2041, 2140, 2141 BE

2050, 2150 DC/DC converter

2060, 2061, 2160, 2161 Local memory

2070, 2071, 2107, 2171 CPU

2080, 2180 Environment management control unit

2081 HOTLINE signal

2090, 2190 EEPROM

2500 Management terminal screen

2501 Device IP address entry area

2052 Component information selection button

2503 Warning information/failure message display button

2504 Trace start button

2505 Component status information display area

2506 Normal component display area

2507 Warning component display area

2508 Blocked component display area

2509 Warning information/failure message display area

3001, 3011, 3101, 3111 Expander

3002, 3012, 3102, 3112 Expander control unit

3003,3013, 3103, 3113 EEPROM

20000, 20001 SFP

20010, 20011 Port

20021 Host communication protocol chip (CHA_I/F controller)

20031, 20402 EEPROM

20041, 20441 Controller interface unit

20400, 20401, 20410, 20411 Connection line

20405, 20406, 30010, 30011 Physical port

20420 Storage device control protocol chip (DKA_I/F controller)

20700, 20701, 20710, 20711 CORE

20705, 20706 20715, 20716 LM

21400, 21401, 21410, 21411 Connection line

30012, 30013, 30014, 30015 Physical port

30016 Storage device switch unit

1. A storage sub-system coupled to a host computer, comprising:
a storage device unit for storing data sent from the host computer; and
a management unit for managing a memory area of the storage device unit;
wherein when failure occurs to the storage device unit or the management unit itself, the management unit specifies an area in which failure has occurred and isolates the area from the storage sub-system;
analyzes the area in which failure has occurred to specify a specific failure area; and
reconnects the area excluding the specified specific failure area to the storage sub-system.

2. The storage sub-system according to claim 1, wherein when failure occurs, a normal management unit blocks the management unit or the storage device unit in which failure has occurred, and acquires a failure information thereof.

3. The storage sub-system according to claim 2, wherein when failure occurs, the normal management unit orders execution of a self diagnosis operation regarding the management unit or the storage device unit in which failure has occurred, so as to specify the specific failure area.

4. The storage sub-system according to claim 3, wherein if the failure area is detected via the self diagnosis, a detailed failure information including a specific failure area information and failure contents is acquired and the detailed failure information is stored in a nonvolatile memory of the management unit, wherein the specific failure area is specified and blocked based on the detailed failure information and a failure management information determining the blocked area and a re-connection availability, and a failure area isolation information is created.

5. The storage sub-system according to claim 4, wherein the specific failure area blocked based on the failure area isolation information is isolated from the normal area so as to perform reconnection to the storage sub-system and reoperation of the normal area.

6. The storage sub-system according to claim 5, wherein the reconnection to the storage sub-system and the reoperation is performed by updating a failure status information via the failure area isolation information, updating a load status management information and an associated storage device information, and planarizing the load of each area within the storage sub-system.

7. The storage sub-system according to claim 4, wherein the failure status information includes one or more of the following information: a failure occurrence time information, an operation status information, a blocked area information, a detailed blocked area information, other management unit operation status information, cluster operation availability information and maintenance and replacement status information.

8. The storage sub-system according to claim 4, wherein the detailed failure information includes one or more of the following information:
a failure occurrence date information, a self diagnosis date information, a diagnosis result information, a maintenance history information, a failure area information, a failure contents information and a component replacement order information.

9. The storage sub-system according to claim 4, wherein the failure management information includes one or more of the following information: a failure area information, a specific failure area information, a blocked area information, a failure response information, a reconnection availability information, a maintenance target area information, a failure notice level information, and failure notice contents.

10. The storage sub-system according to claim 4, wherein the failure area isolation information includes one or more of the following information: a failure occurrence management unit information, a blocked area information, a reconnection availability information, a maintenance target area information, and a blockage number information.

11. The storage sub-system according to claim 4, wherein the nonvolatile memory is a contactless IC memory card.

12. The storage sub-system according to claim 2, wherein the failure information is notified to a management terminal coupled to the storage sub-system, and the failure information is displayed on a screen of the management terminal.

13. The storage sub-system according to claim 12, wherein the failure information is notified to a maintenance center coupled to the management terminal.

14. A method for reusing a resource of a storage sub-system coupled to a host computer, the storage sub-system comprising:
a storage device unit for storing data sent from the host computer; and
a management unit for managing a memory area of the storage device unit;
wherein when failure occurs to the storage device unit or the management unit itself, the management unit specifies an area in which failure has occurred and isolates the area from the storage sub-system;
analyzes the area in which failure has occurred to specify a specific failure area; and
reconnects the area excluding the specified specific failure area to the storage sub-system.

15. The method for reusing a resource according to claim 14, wherein when failure occurs, a normal management unit blocks the management unit or the storage device unit in which failure has occurred, and acquires a failure information thereof.

16. The method for reusing a resource according to claim 15, wherein when failure occurs, the normal management unit orders execution of a self diagnosis operation regarding the management unit or the storage device unit in which failure has occurred, so as to specify the specific failure area.

17. The method for reusing a resource according to claim 16, wherein if the failure area is detected via the self diagnosis, a detailed failure information including a specific failure area information and failure contents is acquired and the detailed failure information is stored in a nonvolatile memory of the management unit, wherein the specific failure area is specified and blocked based on the detailed failure information and a failure management information determining the blocked area and a reconnection availability, and a failure area isolation information is created.

18. The method for reusing a resource according to claim 17, wherein the specific failure area blocked based on the failure area isolation information is isolated from the normal area so as to perform re-connection to the storage sub-system and reoperation of the normal area. reconnection to the storage sub-system and reoperation thereof is performed by updating a failure status information via the failure area isolation information, updating a load status management information and an associated storage device information, and planarizing the load of each area within the storage sub-system.
